(19) United States
(12) Patent Application Publication
(10) Pub. No.: US 2021/0321035 A1
(43) Pub. Date: Oct. 14, 2021

(54) IMAGE PROCESSING METHODS AND SYSTEMS

(71) Applicant: DIGITAL ANIMAL INTERACTIVE INC., Vancouver (CA)

(72) Inventors: Jamie Roy SHERRAH, Athelstone (AU); Michael HENSON, Vancouver (CA); William Ryan SMITH, Vancouver (CA)

(21) Appl. No.: 17/272,191

(22) PCT Filed: Aug. 30, 2019
(86) PCT No.: PCT/CA2019/051212

§ 371 Date: Feb. 26, 2021

Related U.S. Application Data
(60) Provisional application No. 62/726,204, filed on Sep. 1, 2018.

(51) Int. Cl. H04N 5/232; G06K 9/00; G06T 7/73; G06T 7/20; G06T 7/00

(52) U.S. Cl. CPC H04N 5/23219; G06K 9/00362; G06T 7/74; G06T 7/20; H04N 5/23222; G06T 7/0002; G06T 2207/10016; G06T 2207/30244; G06T 2207/20081; G06T 2207/20084; G06T 2207/20076; G06T 2207/30168; G06T 2207/30196

(57) ABSTRACT

A computer-implemented method performable with an imaging device comprises selecting a frame from a video feed output with the imaging device during a movement of the imaging device relative to a body part and detecting the body part in the frame. If the body part is detected, a first process is performed comprising: calculating an azimuth angle of the imaging device relative to the body part, calculating a metering region for the body part, and measuring a motion characteristic of the movement. The method also involves qualifying the frame based on at least one of the azimuth angle and the motion characteristic. If the frame is qualified, a second process is performed comprising: adjusting a setting of the imaging device based on the metering region, capturing an image of the body part with the imaging device based on the setting, identifying a location of the image relative to the body part based on the azimuth angle, and associating the image with a reference to the location.

### TECHNICAL FIELD

Aspects of the present disclosure generally relate to image processing methods and systems. Particular aspects relate to image-based fit determinations for wearable goods such as footwear.

### BACKGROUND

Scanning all or portions of the human body can be useful for making fit determinations for wearable goods, such as apparel and footwear. Known scanning methods often require specialized hardware not generally accessible to consumers, such as measurement booths, 3D depth sensing scanners, and related scanning equipment. Using a readily accessible imaging device such as an iPhone® to perform the scanning would allow the consumers to make at-home fit determinations for wearable goods of a vendor, potentially reducing transportation costs for the consumers and return costs for the vendor.

But most imaging devices do not typically have sensors capable of performing known scanning methods, such as 3D depth sensing scanners. Most imaging devices do, however, have an optical camera. Conventional computer vision methods may be applied to obtain 3D measurements of body parts based on 2D images of the body parts taken from the optical camera. Yet these known methods often require expert guidance and may lack the accuracy necessary for making fit determinations.

### DETAILED DESCRIPTION

Aspects of the present disclosure generally relate to image processing methods and systems. Particular aspects relate to fit determinations for wearable goods. For example, some aspects are described with reference exemplary methods and systems for capturing images of a body part with an imaging device during a movement of the device relative to the body part and performing various functions based on the captured images. Any descriptions of a particular body part (such as a foot or feet), imaging device (such as an iPhone), movement (such as a sweeping motion), or function (such as determining fit) are provided for convenience and not intended to limit the present disclosure unless claimed. Accordingly, the concepts underlying each aspect may be utilized for any analogous method or system.

Inclusive terms such as “comprises,” “comprising,” or any variation thereof, are intended to cover a non-exclusive inclusion, such that an aspect of a method or apparatus that comprises a list of elements does not include only those elements, but may include other elements not expressly listed or inherent to such aspect. In addition, the term “exemplary” is used in the sense of “example,” rather than “ideal.”

Various algorithms and related computational processes are described as comprising operations on data stored within a computer memory. An algorithm is generally a self-consistent sequence of operations leading to a desired result. The operations typically require or involve physical manipulations of physical quantities, such as electrical or magnetic signals capable of being stored, transferred, combined, compared, and otherwise manipulated. For convenience, aspects of this disclosure may refer to these signals conceptually as bits, characters, elements, numbers, symbols, terms, values, or the like.

Functional terms such as “processing,” “computing,” “calculating,” “determining,” “displaying,” and the like, refer to actions and processes performable by a processing unit of an imaging device or similar electronic device. For example, the processing unit may comprise a processor(s) that manipulates and transforms data represented as physical (electronic) quantities within the unit's registers and memories into other data similarly represented as physical quantities within the unit's memories or registers and/or other data storage, transmission, or display devices.

The term “processing unit” may refer to any combination of one or more processor(s) and/or processing element(s), including any resources disposed local to or remote from the imaging device and one another. For example, the processing unit may comprise processor(s) that are local to the imaging device and in communication with other processor(s) over an internet connection, each processor having memory, allowing data to be obtained, processed, and stored in many different ways. As a further example, a single processing unit local to the imaging device may perform some or all of the operations described herein.

Functional terms such as “process” or “processes” also may be used interchangeably with terms such as “method(s)” or “operation(s)” or “procedure(s)” or “program(s)” or “step(s)”, any of which may describe operations performable with the processing unit. For example, the imaging device may comprise a processing unit specially constructed to perform the described processes; or a general purpose computer operable with a computer program(s) to perform the described processes. The program(s) may comprise program code stored in a machine (e.g. computer) readable storage medium, which may comprise any mechanism for storing or transmitting data and information in a form readable by a machine (e.g., a computer). A list of examples may comprise: read only memory (“ROM”); random access memory (“RAM”); erasable programmable ROMs (EPROMs); electrically erasable programmable ROMs (EEPROMs); magnetic or optical cards or disks; flash memory devices; and/or any electrical, optical, acoustical or other form of propagated signals (e.g., carrier waves, infrared signals, digital signals, etc.).

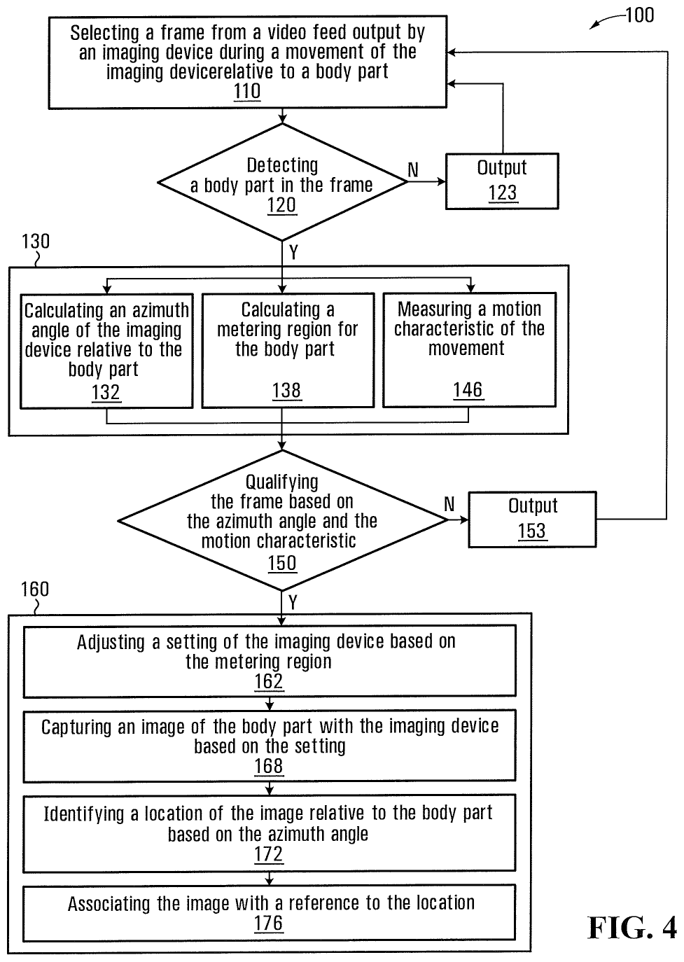

Some aspects are described with reference to conceptual drawings, such as flowcharts with boxes interconnected by arrows. The boxes may be combined, interconnected, and/or interchangeable to provide options for additional modifications according to this disclosure. Each box may include a title, and some of the titles may pose questions. In this disclosure, the titles and questions may be used to outline computer-implemented method steps. For example, each title or question may represent a discrete operation performable by the processing unit of the imaging device in response to a control signal input to the imaging device. The arrows may define an exemplary sequence of these operations. Although not required, the order of the sequence may be important. For example, the order of some sequences depicted in FIGS. 4-15 may be used to realize specific processing benefits, such as improving a performance of the processing unit.

Aspects of this disclosure fuse together Artificial Intelligence based computer vision with conventional computer vision, sensor data, and human computer interaction techniques to generate highly accurate fit determinations for wearable goods. Some aspects utilize a conventional imaging device to efficiently capture high-quality images of a body part; and generate highly accurate fit determinations for the body part based on the high-quality images. The body part may comprise feet. For example, in some aspects, the fit determinations may comprise a predicted length of the feet calculated with an error rate of less than 1% because the underlying images were captured according to this disclosure and are thus substantially devoid of visible blurring, high-resolution, properly focused, sufficiently contrasted, and otherwise optimized as fit determination data.

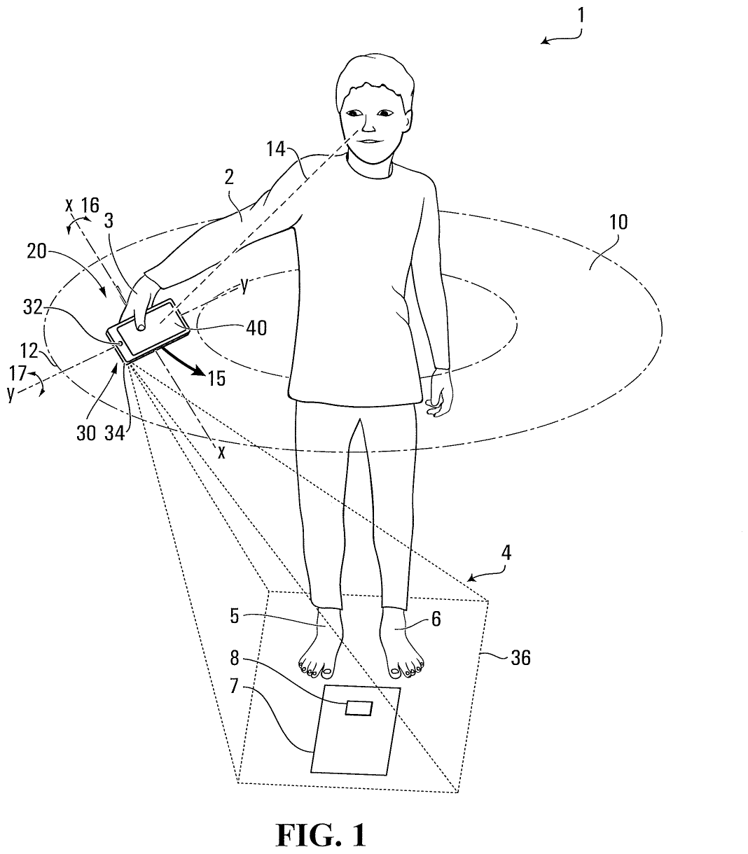

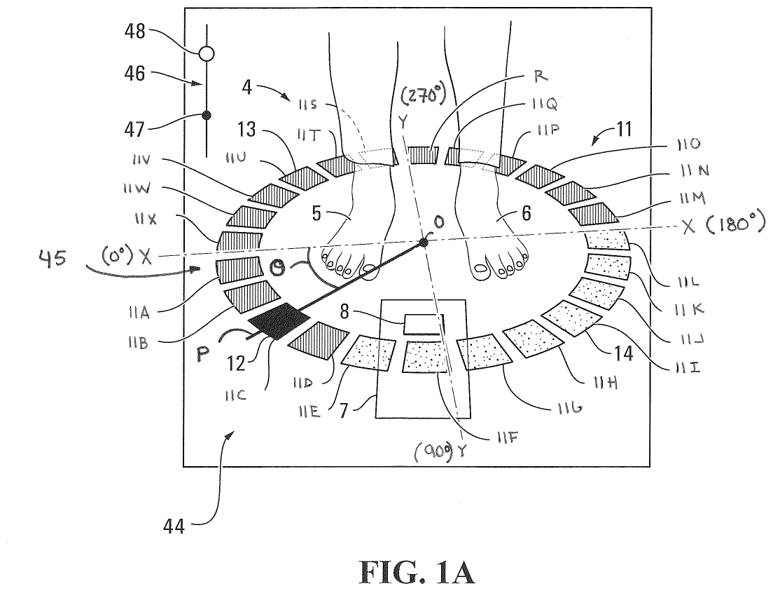

Aspects of this disclosure are now described with reference to FIG. 1, which shows a user 1 obtaining fit determinations for a body part 4 with an imaging device 20 during a movement 15 of imaging device 20 relative to body part 4. Body part 4 may comprise any portion of user 1, including any portion of the upper or lower torso of user 1. Part 4 of FIG. 1, for example, comprises a first or right foot 5 and a second or left foot 6. As shown, user 1 may grip imaging device 20 in a hand 3 of an arm 2; and perform movement 15 by moving device 20 with arm 2. Movement 15 may comprise any movements of device 20 relative to part 4, including the circular movement around body part 4 depicted in FIG. 1 and any related movements for starting, maintaining, and/or stopping said movement.

Various aspects for locating imaging device 20 relative to body part 4 are described. Some aspects are described with reference to an azimuth angle θ and a plurality of pose segments 11. As shown in FIG. 1A, body part 4 (e.g., feet 5 and 6) may be located on a ground plane, and azimuth angle θ may comprise an angular location on the ground plane. For example, imaging device 20 may: (i) locate the ground plane by any means; (ii) define a first axis X-X on the ground plane as extending transversely through feet 5 and 6; (iii) locate an origin point O on axis X-X between feet 5 and 6; and (iv) define a second axis Y-Y on the ground plane as extending transversely through axis X-X at origin point O in a direction parallel to feet 5 and 6 so that azimuth angle 8 of FIG. 1 may be defined relative to axes X-X and Y-Y with a position line P that rotates about point O responsive to movement 15. In this example, axes X-X and Y-Y may be defined relative to body part 4 independently of imaging device 20 so that each azimuth angle θ corresponds with a different viewpoint of device 20 relative to part 4.

As also shown in FIG. 1A, plurality of pose segments 11 may be spaced apart around origin point O in a radial configuration so that each pose segment comprises a range of azimuth angles θ. For example, pose segments 11 of FIGS. 1A and 30-32 may comprise twenty-four (24) pose segments marked 11A through 11X so that each segment 11 comprises a 15 degree range of azimuth angles θ. As shown, first axis X-X may extend relative edge of segments 11A/11X and 11L/11M so that position line P may define azimuth angles θ of 0 and 180 degrees respectfully; and second axis Y-Y may extend relative to an edge of segments 11F/11G and 11R/11S so that position line P may define azimuth angles θ of 90 and 270 degrees respectfully. Accordingly, as shown in FIG. 1A, position line P may extend through pose segment 11C during movement 15 so that imaging device 20 has an azimuth angle θ of between 35 and 45 degrees relative axis X-X.

Numerous image processing methods may be performed with imaging device 20 during movement 15. For example, such methods may be broadly described as comprising: (i) inputting a video feed of body part 4 during movement 15; (ii) capturing an image of body part 4 based on the video feed; and (iii) performing calculations based on the images. The calculations may be based upon a scale of body part 4, and imaging device 20 may determine the scale based upon a scaling object 8 according to any scaling method. As shown in FIGS. 1 and 1A, for example, scaling object 8 may comprise any visually measurable object of a known size, such as a credit placed on a floor between feet 5 and 6 for inclusion in each frame of the video feed.

Patterns on the floor may affect the determination of scale by making it more difficult for imaging device 20 to determine a boundary of scaling object 8. To accommodate the patterns, scaling object 8 may be placed in or on a brightness reference area 7. Brightness reference area 7 may provide contrast for segmentation of the card in the images captured during second processing step 160 of FIG. 4 described below. As shown in FIGS. 1 and 1A, for example, reference area 7 of FIGS. 1 and 1A may comprise a painted area of the floor, a graphical floor covering attached to the floor (e.g., such as a depiction pose segments 11 described below), or even a white piece of piece of paper placed on the floor.

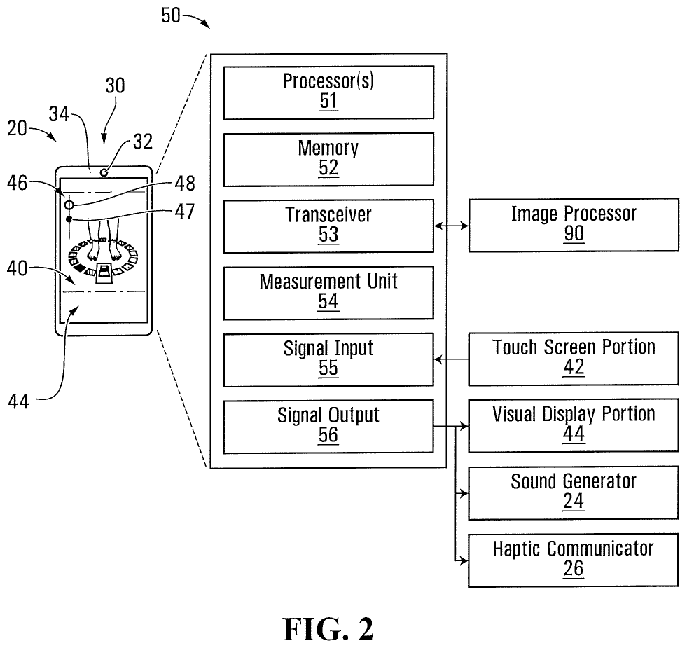

Imaging device 20 may comprise any type of computing device. As shown in FIG. 2, imaging device 20 may comprise at least: a camera unit 30; a display 40; and a processing unit 50. For example, imaging device 20 may comprise any mobile computing device belonging to a class of devices comprising: a personal computer, such as MacBook® or its equivalent; a smart phone, such as the iPhone or its equivalent; a smart watch, such as the iWatch® or its equivalent; and/or a tablet, such as an iPad® or its equivalent. As a further example, some aspects described herein may comprise program code that is downloadable onto and/or performable with any operating system of any processing unit 50 of any device 20.

Camera unit 30 may comprise any cameras of any type. For example, camera unit 30 of FIGS. 1 and 2 may comprise at least one optical camera operable with processing unit 50 to output high-resolution images at a spatial resolution of approximately eight million pixels per image and a typical width to height aspect ratio of nine to sixteen. As shown in FIG. 1, camera unit 30 may comprise a first or forward-facing optical camera 32 oriented toward user 1 and a second or rearward-facing optical camera 34 oriented away from user 1. The video feed may be output with either camera 32 or 34 to include an image capture area 36 surrounding body part 4.

Display 40 may comprise any visual display technologies. For example, display 40 of FIGS. 1 and 2 may comprise: a touchscreen portion 42 operable to input control signals from user 1; and a visual display portion 44 operable to output positioning instructions to user 1. Portions 42 and 44 may comprise any and/or all of display 40, and may overlap. As shown in FIG. 1, a sight line L between visual display portion 44 and user 1 may be maintained during movement 15. For example, display portion 44 and forward-facing camera 32 may be located on the same, forward-facing side of imaging device 20; and rearward-facing camera 34 may be utilized to input the video feed, making it easy for user 1 to maintain sight line L during movement 15.

Imaging device 20 may output positioning instructions to user 1 for guiding aspects of movement 15. The positioning instructions may be visual. As shown in FIG. 1A, visual output portion 44 may output the video feed and positioning instructions comprising: an augmented reality element 45 and a visual signal 46. For example, the video feed may show feet 5 and/or 6; and augmented reality element 45 may comprise a depiction of plurality of pose segments 11 overlaid around feet 5 and 6. In this example, aspects of augmented reality element 45 and visual signal 46 may be movable in response to movement 15, and the movable aspects may guide user 1 so long as sight line L is maintained.

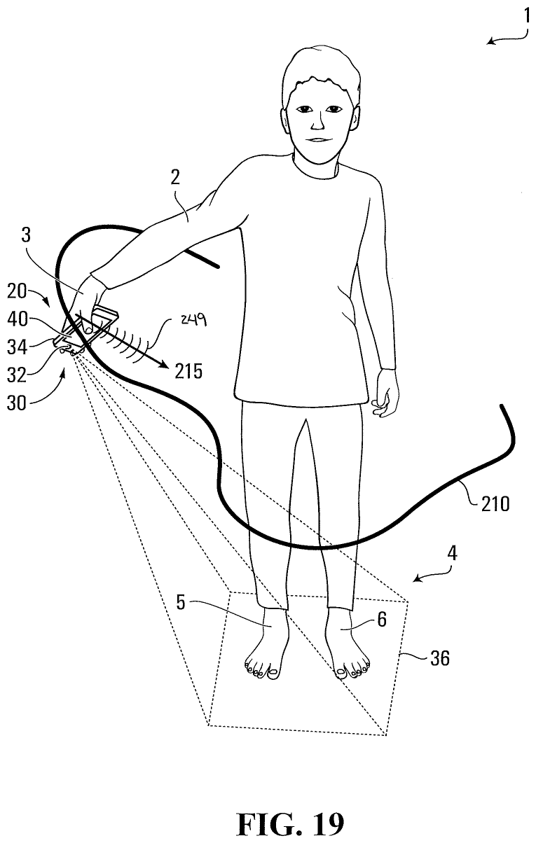

As also described further below, the positioning instructions may be non-visual so that imaging device 20 may guide user 1 even when sight line L is not or cannot be maintained (e.g., FIG. 19). For example, imaging device 20 of FIG. 2 may comprise a sound generator 24 (e.g., a speaker) and/or a haptic communicator 26 (e.g., a vibrator); and the position instructions may comprise any audio and/or haptic signals output therewith to guide any movement of imaging device 20 relative to body part 4.

Processing unit 50 may comprise any computational resources local to and/or in communication with imaging device 20. As shown in FIG. 2, unit 50 may comprise: a processor 51; a memory 52; a transceiver 53; a measurement unit 54; a signal input 55; and a signal output 56. Processor 51 may comprise any combination of central processors and general processors. Memory 52 may comprise any combination of program memory operable with processor 51 to store program code and variable memory operable with processor 51 to store input and output data. Transceiver 53 may comprise any type of wired or wireless communication technologies operable to input or output the data. For example, transceiver 53 of FIG. 2 may comprise any wireless technologies (e.g., BlueTooth®, cellular, Wi-Fi, and like technologies) for communicating with a remote image processor 90 over an internet connection to input fit determination data from imaging device 20 to image processor 90, and output one or more recommendations from processor 90 to device 20 (e.g., in fit determination process 190 described below).

Measurement unit 54 may comprise any technologies for outputting position data responsive to movements of imaging device 30, including any sensors for measuring angular rates, forces, and/or positions of imaging device 20. For example, measurement unit 54 of FIG. 2 may comprise an inertial measurement unit configured to output the position data with any combination of accelerometer(s), gyroscope(s), and/or magnetometer(s).

Signal input 55 may comprise any technologies operable to input control signals from user 1. For example, signal input 55 of FIG. 2 may comprise circuits operable with touchscreen portion 42 to input a haptic control signal for initiating the video feed with processing unit 50; circuits operable with an audio input of imaging device 20 (e.g., a microphone) to input audible control signals; and/or circuits operable with a visual input of device 20 (e.g., forward-facing camera 32) to input visual control signals. Signal output 56 may comprise any technologies operable to communicate positioning instructions to user 1. For example, signal output 56 of FIG. 2 may comprise circuits operable with processing unit 50 to communicate positioning instructions to user 1 with visual display portion 44, sound generator 24, and/or haptic communicator 26.

Processing unit 50 may be operable with the program code stored on memory 52 to perform any function described herein. Any program code language may be used. For example, processing unit 50 may be operable to perform various functions according to the program code by: inputting data from camera unit 30, the touchscreen portion 42 of display 40, transceiver 53, measurement unit 54, and/or signal input 55; performing various calculations with processor 51 based on the data; and outputting control signals to camera unit 30, visual display portion 44 of display 40, and/or signal output 56 based on the calculations.

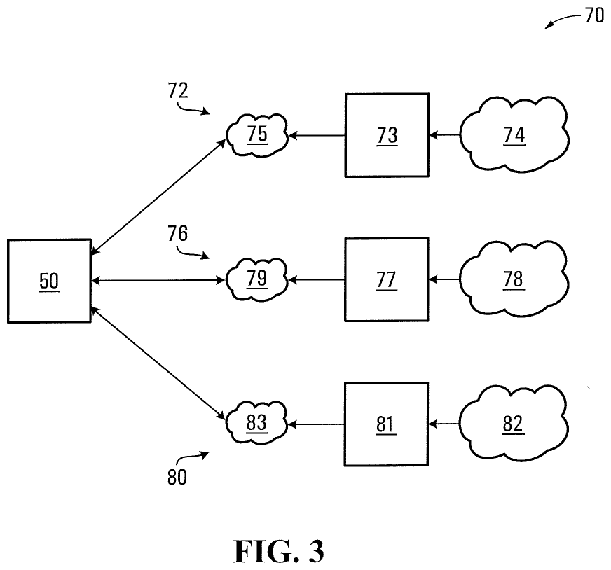

As shown in FIG. 3, processing unit 50 may comprise a neural network 70 that is defined by the program code and trained off-line to perform certain functions according to a machine learning process. Neural network 70 may comprise a plurality of neural networks, and each network may be defined by an algorithm and trained to perform a different function according to a different machine learning process. As shown in FIG. 3, for example, neural network 70 may comprise: a first neural network 72 trained to perform a first function according to a first machine learning process; a second neural network 76 trained to perform a second function according to a second machine learning process; and a third neural network 80 trained to perform a third function according to a third machine learning process.

Each machine learning process may be similar. For example, each machine learning process may broadly comprise generating parameters off-line based on training data, inputting new data, and applying the parameters to the new data. As shown in FIG. 3, for example, first neural network 72 may generate first parameters 73 off-line based on first training data 74, input first new data 75, and apply parameters 73 to data 75; second neural network 76 may generate second parameters 77 off-line based on second training data 78, input second new data 79, and apply parameters 77 to data 79; and third neural network 80 may generate third parameters 81 off-line based on third training data 82, input third new data 83, and apply parameters 81 to data 83.

Each training data 74, 78, and 82 may be specific to body part 4. For example, if body part 4 comprises feet, as in FIGS. 1 and 1A, then data 74, 78, and 82 may comprise thousands of images of other feet. In this example, neural networks 72, 76, and 80 may: generate parameters 73, 77, and 81 off-line by analysing the images of other feet in a supervised and/or unsupervised manner. Once generated, neural networks 72, 76, and 80 may then input new data 75, 79, and 83 comprising a frame selected from the video feed; and output predictions for the frame by applying parameters 73, 77, or 81 to data 75, 79, or 83. For example, a plurality of successive frames from the video feed may be processed so that networks 72, 76, and 80 may continuously output the predictions during movement 15.

Program structures for an exemplary image processing method 100 are shown in FIGS. 4-15 and now described. As shown in FIG. 4, image processing method 100 may comprise: selecting a frame from a video feed output with imaging device 20 during any movement of device 20 relative to body part 4 (“selecting step 110”); detecting body part 4 in the frame (“detecting step 120”); performing, if body part 4 is detected, a first process for analysing the frame; (“first processing step 130”); qualifying the frame based on an output of the first imaging process (“qualifying step 150”); and performing, if the frame is qualified, a second imaging process for capturing an image based on the frame (“second processing step 160”).

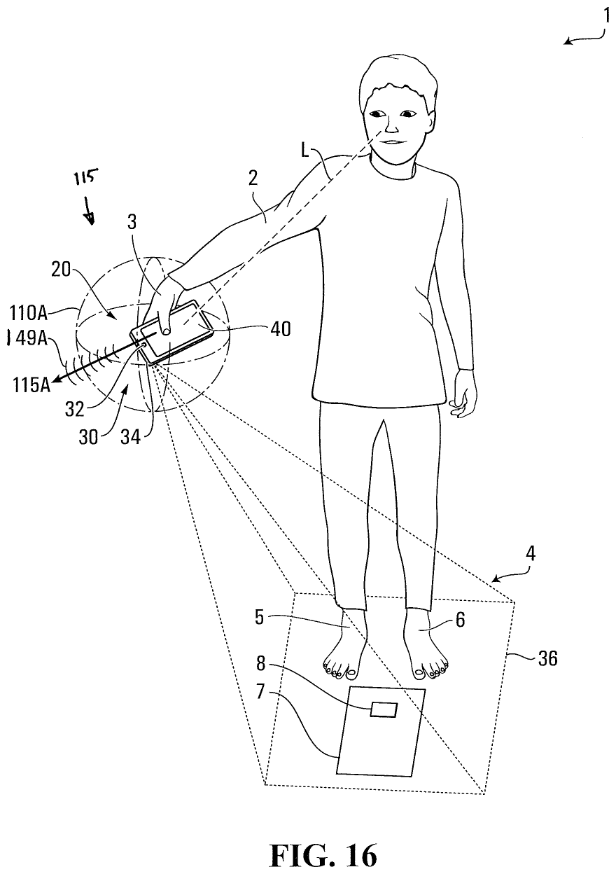

Selecting step 110 may be performed during any movement of imaging device 20 relative to body part 4, such as movement 15 of FIG. 1. Movement 15 may be performed within a viewpoint region 10 located relative to user 1. As shown in FIGS. 1 and 1A, movement 15 may comprise a circular movement corresponding to the radial arrangement of plurality of pose segments 11; and viewpoint region 10 may comprise a circular shape corresponding with the circular movement. Other exemplary movements of imaging device 20 are shown in FIGS. 16-19 and described further below. For example, selecting step 110 may be similarly performed during a segmented movement 115 of FIGS. 16-18, in which imaging device 20 is moved between different viewpoint regions 110A, 110B, and 110C about body part 4; and a random movement 215 of FIG. 19, in which device 20 is moved along any path 210 relative to part 4.

Neural network 70 may be trained to perform detecting step 120 according to a machine learning process. For example, first neural network 72 may be trained to perform detecting step 120 according to a first machine learning process for detecting the body part 4 in the frame. As shown in FIGS. 1 and 3, body part 4 may comprise feet (e.g., foot 5 and/or 6); first training data 74 may comprise images of other feet; and first parameters 73 may comprise parameters generated off-line by analysing the images of other feet using supervised and/or unsupervised training techniques. Accordingly, first neural network 72 may continuously input each frame selected during step 110 as first new data 75, and output predictions for the detection of body part 4 by applying the parameters to the frame.

First neural network 72 may comprise a deep convolutional neural network (CNN) operable to perform step 120. For example, step 120 may comprise inputting each frame from step 110 to the CNN as an image; applying transforming feature layers to each image with the CNN; and outputting predictions from the CNN for each image. The CNN may comprise a classification model having a structure and parameters. The structure may be chosen by the designer and the parameters may be estimated by training the CNN on a ground-truth labelled data set comprising many pairs of (image, presenceFlag). After training, the CNN (including its parameters) may be used for inference within detection step 120. The predictions output from the CNN may comprise confidence scores for detecting body part 4 in each frame from step 110. For example, each confidence score may be located in a range of [0,1] indicating how confident the CNN is that body part 4 has been detected in the frame during step 120.

The data structure of first neural network 72 may comprise a sequence of convolutions followed by a nonlinear transformation, followed by pooling and down-sampling. The input to each layer may be the output of the previous layer. Each layer may be considered a feature detector, and the outputs may comprise detection strengths for abstract features. For example, first neural network 72 may comprise a hierarchical feature extractor comprising early layers, intermediate layers, and final layers. In this example, the early layers may comprise low-level feature detectors operable to extract low-level features, such as edges and blobs; the deeper, intermediate layers may compose the low-level features into more complex, high-level features, like object parts; and the deepest, final layers may combine the high-level features using fully connected layers to produce class predictions based on the high-level features.

Various training techniques may be used to train first neural network 72. For example, one aspect of the training may comprise an optimisation method performable with first network 72 to minimise the misclassification error of network 72 based on first training data 74. The optimisation method may utilize stochastic gradient descent so that: given a training image, the current output of the network is computed. In this example, the difference from the target output (ground truth) may be used as an error correction signal, which may be back-propagated through network 72 to compute gradients of the weights (parameters). The weights may then be updated by adding a modification step in proportion to the gradient, resulting in a change to the weights and a corresponding correction of the final output.

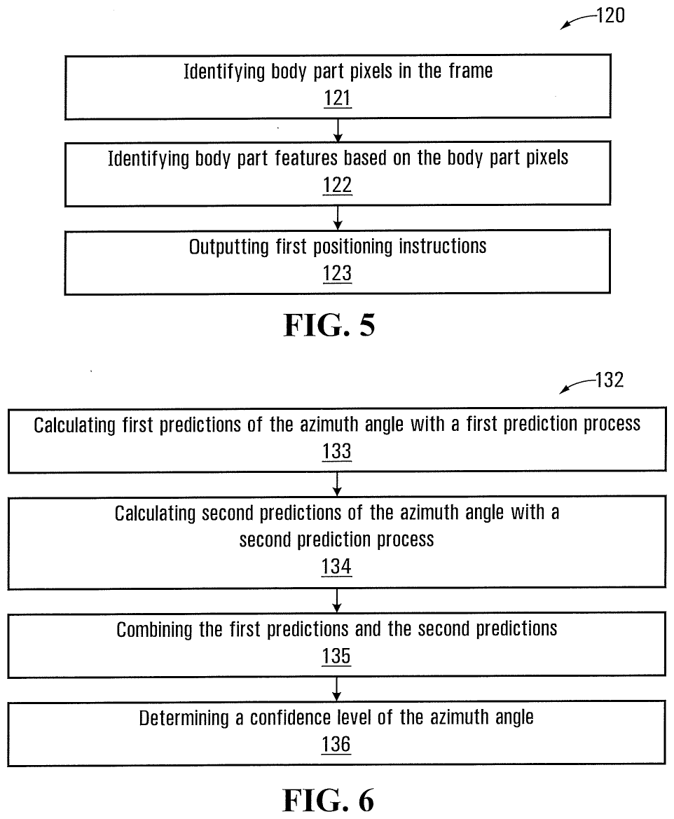

According to these aspects, first neural network 72 may perform a certain kind of computation, feature extraction, composition, and classification process, in which the resulting predictions are not prescribed, but emergent properties of the training. First network 72 also may comprise other, more prescribed steps. For example, as shown in FIG. 5, detecting step 120 may comprise: identifying body part pixels in the frame (“first detecting step 121”); and identifying body part features based on the body part pixels (“second detecting step 122”).

Neural network 70 may be similarly trained to perform one or both of detecting steps 121 and 122 according to a machine learning process. For example, first neural network 72 may be trained to perform steps 121 and 122 according to the first machine learning process; and the parameters may comprise: a hierarchy of known body part pixel characteristics and a hierarchy of known body part features. In this example, first detecting step 121 may comprise: calculating a body part probability for each pixel of the frame by applying the hierarchy of known body part pixel characteristics to each pixel; and thresholding the calculated body part probabilities based on a predetermined value, resulting in a binary image of the frame comprising clusters of the body part pixels. In complement, second detecting step 122 may comprise: calculating a body part probability for each cluster of body part pixels by applying the hierarchy of known body part features to each cluster; and detecting body part 4 based on the body part probabilities.

As shown in FIGS. 4 and 5, detecting step 120 also may comprise outputting positioning instructions to user 1 (“outputting step 123”). For example, outputting step 123 may comprise first positioning instructions for locating body part 4 in the frame by guiding first additional movements of imaging device 20 relative to body part 4 during movement 15.

First processing step 130 for analysing the frame may be performed by processing unit 50 whenever body part 4 is detected in the frame during step 120. As shown in FIG. 4, for example, first processing step 130 may comprise: calculating azimuth angle 8 of imaging device 20 relative to body part 4 (“first calculating step 132”); calculating a metering region for body part 4 (“second calculating step 138”); and measuring a motion characteristic of the movement (“third calculating step 146”). Steps 132, 138, and 146 may be performed by processing unit 50 in a parallel or serial manner to maximize the performance of processor 51 and/or memory 52. In some aspects, steps 132, 138, and 146 may be performed continuously so that step 130 comprises continuously outputting data based on the frame.

Numerous means for calculating azimuth angle e may be utilized in step 132 to modify and/or improve the accuracy of method 100. For example, as shown in FIG. 6, first calculating step 132 may comprise: calculating first predictions of azimuth angle θ with a first prediction process (“first predicting step 133”); calculating second predictions of azimuth angle θ with a second prediction process (“second predicting step 134”); and combining the first predictions and the second predictions (“combining step 135”).

Neural network 70 may be trained to perform first prediction step 133 according to a machine learning process. For example, second neural network 76 may be trained to perform step 133 according to a second machine learning process for mapping azimuth angle a on the frame. Similar to above, body part 4 may comprise feet 5 and/or 6; second training data 78 may comprise images of other feet (the same or different than those of data set 74); and second parameters 77 may comprise mapping parameters generated off-line by analysing the images of other feet using supervised and/or unsupervised training techniques. Accordingly, second neural network 76 may continuously input each frame selected during step 110 as second new data 79, and output the first predictions of azimuth angle θ by applying the mapping parameters to each frame.

The output of second neural network 76 may be different from the output of first neural network 72. For example, the output of first network 72 may comprise confidence scores in the rage of [0,1]; whereas the first predictions output from second network 76 may encode azimuth angle θ. In this example, the ground truth (i.e., the known information) may come from 3D reconstructions and estimated camera locations in a multiple view geometry processing pipeline. When projected onto the ground plane, the estimated camera locations may give azimuth angle θ.

The first predictions from network 76 may comprise a measure of azimuth angle a in degrees, making the second machine learning process operable to solve a regression problem. Aspects of this output may be problematic, particularly with the discontinuity at 0-360 degrees. Thus, a classification output based on plurality of pose segments 11 may be used to improve the accuracy of method 100. For example, first prediction step 133 may comprise locating the twenty-four segments 11A-X of FIG. 1A relative to body part 4 so that each segment 11A-X comprises an equal arc length of 15 degrees; and second neural network 76 may comprise outputting a first prediction for each segment 11A-X. A one-hot encoding of azimuth angle θ may be used so that: if a given training image corresponds to the i-th segment, then the first predictions may comprise a target vector of 24 zeros with the i-th element equal to 1. As shown in FIG. 1A, for example, an exemplary azimuth angle θ of approximately 142 degrees may correspond to a 3^{rd} segment, such as segment 11C extending between 30 and 45 degrees, so that the target vector comprises: [0, 0, 1, 0, 0, 0, 0, 0, 0, 0, 0, 0, 0, 0, 0, 0, 0, 0, 0, 0, 0, 0, 0, 0].

The first predictions output from second neural network 76 may comprise similar vectors. For example, during first prediction step 133, second network 76 may input the frame from camera unit 30 as an image; and output first predictions comprising an output vector for the frame. Confidence levels may be calculated for each output vector; and the vector element with the highest confidence level may indicate the predicted segment. Since frames from neighbouring segments look similar, second network 76 also may produce intermediate confidences in neighbouring segments, and the intermediate confidences may be interpolated to get a continuous angle output. For example, consider the output vector: [0, 0.5, 0.5, 0, 0, 0, 0, 0, 0, 0, 0, 0, 0, 0, 0, 0, 0, 0, 0, 0, 0, 0, 0, 0]; in which the second segment (15-30 degrees) and third segment (30-45 degrees) both have a confidence of 0.5. In this example, the output vectors may be interpreted as an output angle of 30 degrees, since this is the midpoint between the first and segment segments.

Second predicting step 134 may comprise calculating the second predictions of azimuth angle θ based on a different data source, such as position data from measurement unit 54. For example, the position data may comprise angular rate applied to imaging device 20 during movement 15; and prediction step 134 may comprise calculating the second predictions of azimuth angle 0 based on the angular rate. Other means for calculating the second predictions may be used. For example, the position data may include an elevation of imaging device 20 relative to body part 4 (e.g., determined with measurement unit 54); and second step 134 may comprise calculating the second predictions based on the elevation. As a further example, the second predictions also may be calculated by applying a simultaneous localization and mapping algorithm to the video feed.

Because they originate from different processes, aspects of the first and second predictions may be different. For example, the first predictions may be calculated during first predicting step 133 at a first rate; the second predictions may be calculated during second predicting step 134 at a second rate; and the first rate may different from the second rate. In some aspects, the first rate may be based on a frame rate of the video feed (e.g., 10 frames per second); and the second rate may be based on a sample rate of measurement unit 54 (e.g., 100 samples per second), making the second rate faster than the first rate. Combining step 135 may utilize these differences to improve the accuracy of method 100. For example, step 135 may comprise any means for combining the first and second predictions, including averages, weighted averages, and the like.

As shown in FIG. 6, first calculating step 132 also may comprise determining a confidence level of azimuth angle θ based one or more of the first predictions, the second predictions, and the combination thereof (“determining step 136”). For example, determining step 136 may comprise continuously analysing the one or more of the first estimates, the second estimates, or the combination thereof during the movement.

Neural network 70 may be trained to perform second calculating step 138 according to a machine learning process. For example, third neural network 80 may be trained to perform step 138 according to a third machine learning process for calculating the metering region based on the frame. Similar to above, body part 4 may comprise feet 5 and/or 6; third training data 82 may comprise images of other feet (the same or different than those of data 74 and 78); and third parameters 81 may comprise metering parameters generated off-line by analysing the images of other feet using supervised and/or unsupervised training techniques. Accordingly, third neural network 80 may continuously input each frame selected during step 110 as new data 83, and output predictions for the metering area of body part 4 by applying the metering parameters to the frame.

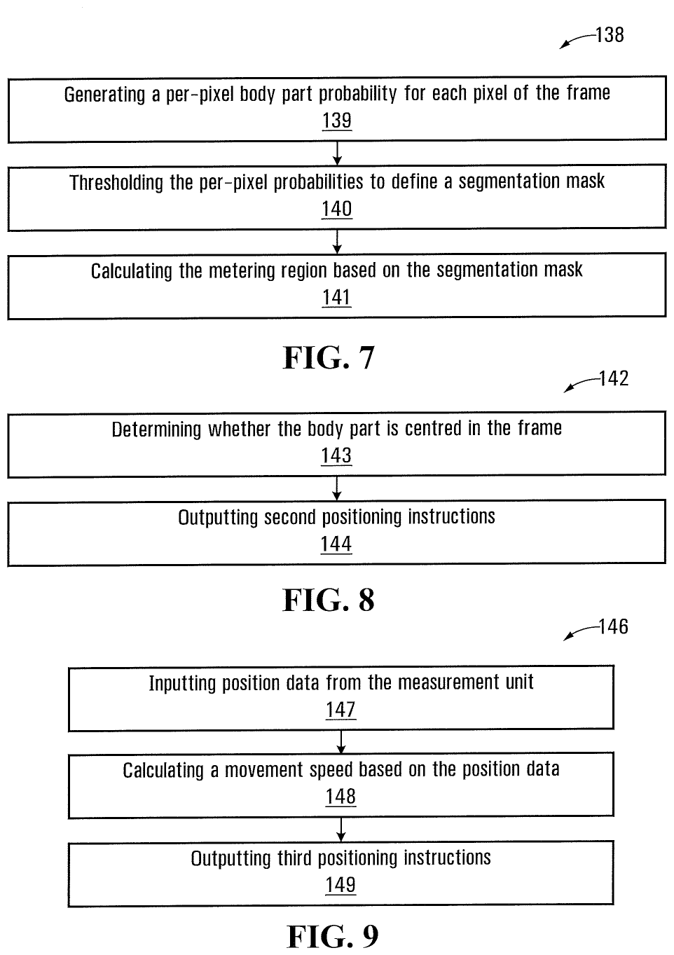

As a further example, shown in FIG. 7, second calculating step 138 may comprise: generating a per-pixel body part probability for each pixel of the frame (“generating step 139”); thresholding the per-pixel probabilities to define a segmentation mask (“thresholding step 140”); and calculating the metering region based on the segmentation mask (“calculating step 141”). Each of steps 139, 140, and 141 may be performed by third neural network 80. For example, the metering parameters may comprise probability parameters and thresholding values; generating step 139 may comprise applying the probability parameters to generate the per-pixel body part probabilities; and thresholding step 140 may comprise applying the thresholding values to define the segmentation mask.

The segmentation mask may show portions of the frame where body part 4 is located, and the metering region may be calculated during step 141 based on these portions. The metering region may comprise any shape sized to include body part 4, such as a box; and calculating step 141 may comprise locating the shape relative to the segmentation mask with an iterative process. For example, the iterative process may comprise: (i) selecting a portion of the segmentation mask; (ii) assuming that the selected portion corresponds to body part 4 using a connected components method; (iii) computing moments of the selected portion; (iv) estimating an initial size of the shape based a square root of the second order moments (i.e., the spatial variances); (v) initialising an initial shape location at the top of the selected portion; (vi) multiplying the segmentation mask by a linear function to generate an R(x,y) image; (vii) applying a mean shift algorithm to the R(x,y) image in order to (a) compute a centroid of the selected portions of the R(x,y) image in the shape and (b) iteratively adjust the shape position based on the centroid until convergence; and (viii) outputting a final, converged shape position as the metering region. In this example, the selected portion may comprise the largest portion of the segmentation mask; and the linear function may comprise a ramp R(x,y)=(H−y)/H, in which “x” and “y” are pixel locations in the frame and “H” is a height of the frame so that masked pixels at the top of the frame are weighted more heavily (e.g., may be displayed brighter than) those near the bottom of the frame.

As shown in FIG. 8, calculation step 138 may comprise a centring process 142 comprising: determining whether body part 4 is centred in the frame based on the segmentation mask generated at step 139 (“determining step 143”); and outputting positioning instructions to user 1 (“outputting step 144”). For example, step 144 may comprise outputting second positioning instructions for centring body part 4 in the frame by guiding second additional movements of device 20 relative to body part 4.

Third calculating step 146 may comprise measuring the motion characteristic of movement 15 with measurement unit 54. The motion characteristic may comprise a movement speed of imaging device 20 relative to body part 4. Accordingly, step 146 may comprise continuously inputting position data from measurement unit 54 (“inputting step 147”); and calculating the movement speed based on the position data (“calculating step 148”). Similar to above, third calculating step 146 also may comprise outputting positioning instructions to user 1 (“outputting step 149”). For example, step 149 also may comprise outputting third positioning instructions for modifying the movement speed by guiding third additional movements of imaging device 20 relative to body part 4

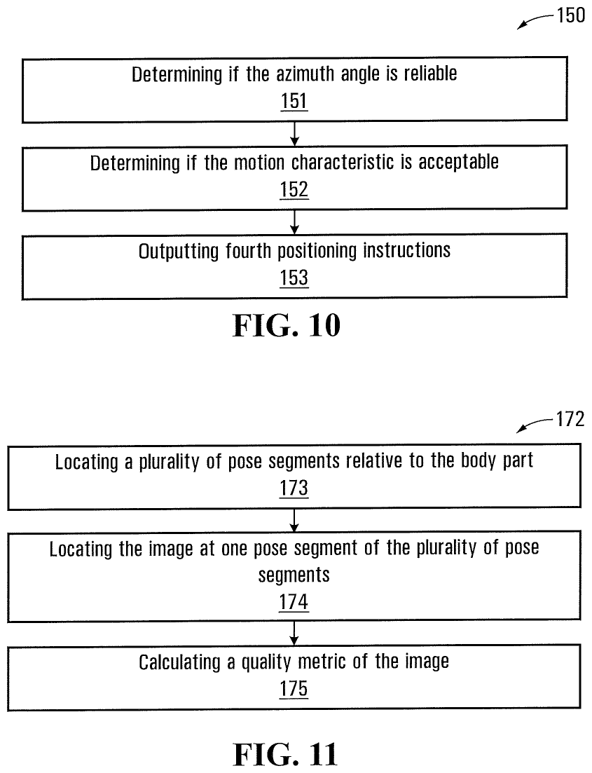

Qualifying step 150 may be performed upon successful calculation of azimuth angle 8 in step 132, the metering region in step 138, and/or the motion characteristic in step 146. In some aspects, at least azimuth angle θ and the motion characteristic may be utilized in qualification step 150. As shown in FIG. 10, for example, step 150 may comprise: determining if azimuth angle 8 is reliable (“determining step 151”); and determining if the motion characteristic is acceptable (“determining step 152”).

Determining step 151 may comprise comparing azimuth angle θ calculated during step 132 with a predetermined range of reliable angles θ. For example, each reliable angle θ in the predetermined range may be spread apart from the next within circular viewpoint region 10 of FIG. 1 to avoid selecting duplicate or near-duplicate frames during step 110. As a further example, determining step 151 also may comprise screening each azimuth angle θ based on the confidence level determined during step 136. Determining step 152 may comprise comparing the motion characteristic measured during step 146 with a predetermined range of acceptable motion characteristics. For example, the motion characteristic may comprise the movement speed of imaging device 20, and each speed in the predetermined range of motion characteristics may be slow enough to minimize blurring when capturing an image based on the frame during step 150.

As shown in FIGS. 4 and 10, qualifying step 150 also may comprise outputting positioning instructions to user 1 (“outputting step 153”). For example, step 153 may comprise outputting a warning signal if step 151 determines that azimuth angle θ is not reliable and/or step 152 determines that the motion characteristic is not acceptable. For example, the warning signal may instruct user 1 to re-start method 100 and/or comprise outputting fourth positioning instructions for restarting the movement by guiding fourth additional movements of imaging device 20 relative to body part 4.

To avoid allocating computational resources to low quality images, second processing step 160 may be performed after qualification of the frame during step 150. Similar to step 130, second processing step 160 may comprise steps performable by processing unit 50 of imaging device 20. For example, as shown in FIG. 4, second processing step 160 may comprise: adjusting a setting of imaging device 20 based on the metering region (“adjusting step 162”); capturing an image of body part 4 with imaging device 20 based on the setting (“capturing step 168”); identifying a location of the image relative to body part 4 (“identifying step 172”); and associating the image with a reference to the location (“associating step 176”).

Adjusting step 162 may comprise steps for iteratively adjusting any setting of imaging device 20 and/or camera unit 30 prior to capturing step 168. For example, step 162 may comprise iteratively adjusting one or more of a focus, an exposure, and a gain of rearward facing optical camera 34 of camera unit 30 of FIG. 1 based on the metering area calculated during step 146 for each frame qualified during step 150.

Capturing step 168 may comprise steps for capturing the image based on the setting(s) of imaging device 20 adjusted during step 162. For example, step 168 may comprise assuming control of camera unit 30, pausing the video feed, and/or activing a flash element operable with camera unit 30. As a further example, each image may comprise a burst of images captured in rapid succession, and capturing step 168 may comprise capturing the burst images with camera unit 30.

Identifying step 172 may comprise steps for locating the image relative to body part 4. As shown in FIG. 11, for example, identifying step 172 may comprise: locating plurality of pose segments 11 relative to body part 4 (“first locating step 173”); and locating the image at a current pose segment 12 of plurality of pose segments 11 (“second locating step 174”).

As shown in FIG. 1A and described above, plurality of pose segments 11 may be located during first locating step 173 (or earlier in method 100) by defining origin point O, first axis X-X, second axis Y-Y relative to feet 5 and 6; and locating segments 11A-X relative thereto. Second locating step 174, for example, may comprise locating the image at current pose segment 12 based on position data output from measurement unit 54. For example, step 174 may comprise: inputting first position data from measurement unit 54 at a first position prior to capturing step 168; inputting second position data from unit 54 at a second position during capturing step 168; and locating the image at current pose segment 12 based on first position data and/or the second position data.

As shown in FIG. 11, identifying step 172 may comprise steps for further qualifying the image. For example, step 172 of FIG. 11 also may comprise calculating a quality metric of the image (“calculation step 175”). The quality metric may be calculated based on data associated with the frame or the image. For example, the quality metric may be based one or more of: azimuth angle θ from step 132; the confidence level from step 132; the motion characteristic from step 146; and a setting of camera unit 30 after step 172, such as the resolution. The quality metric also may be calculated by further analysing the image with processing unit 50. For example, step 172 also may comprise analysing the image with steps for detecting visible blurring, confirming focus, and measuring contrast.

Associating step 176 may comprise steps for generating a reference linking each image captured during step 168 with the location identified during step 172. For example, step 176 may comprise any known image processing steps for optimizing each image for storage; and any known data processing steps for generating the references, and storing the images together with the references in the variable memory of memory 52. The locations may be identified by any means in step 172. For example, in keeping with FIG. 11, associating step 176 also may comprise: associating the image with a reference to plurality of pose segments 11 and/or current pose segment 12.

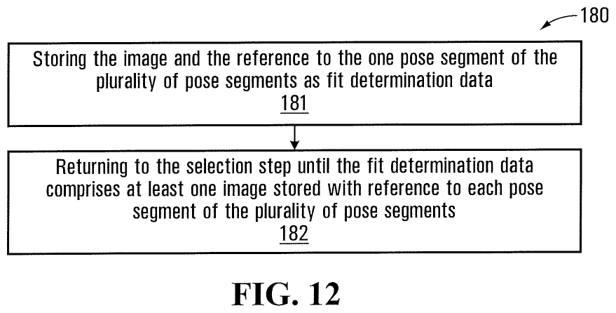

As shown in FIG. 12, method 100 may comprise a storage process 180 performable to generate fit determination data comprising a plurality of images of body part 4 captured during step 168 and the references associated therewith during step 176. For example, storage process 180 of FIG. 12 may comprise: storing the image and the reference to current pose segment 12 in memory 52 as fit determination data (“storing step 181”); and returning to selecting step 110 until the fit determination data comprises at least one image stored with reference to each pose segment of the plurality of pose segments 11 (“returning step 182”). According to storage process 180 of FIG. 12, the plurality of images may be continuously captured during step 168, associated with references during step 176, and stored with the references in memory 52 during step 181 by performing step 182 multiple times per second (e.g., 100 times per second) during any movement of imaging device 20 relative to body part 4, such as movement 15 of FIG. 1.

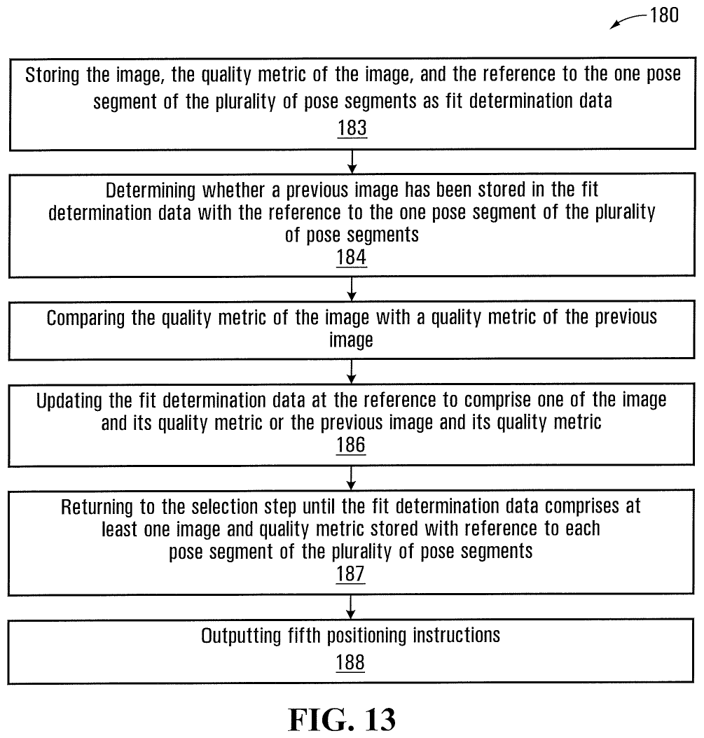

Aspects of storage process 180 may improve the fit determination data based on the quality metric calculated at step 175 of FIG. 11. As shown in FIG. 13, for example, storage process 180 also may comprise: storing the image, the quality metric of the image, and the reference to current pose segment 12 in memory 52 as fit determination data (“storing step 183”); determining whether a previous image has been stored in the fit determination data with the reference to pose segment 12 (“determining step 184”); comparing the quality metric of the image with a quality metric of the previous image (“comparing step 185”); updating the fit determination data at the reference to segment 12 to comprise one of the image and its quality metric or the previous image and its quality metric (“updating step 186”); and returning to selecting step 110 until the fit determination data comprises the at least one image and quality metric stored with reference to each pose segment 11 (“returning step 187”). Similar to above, the plurality of images may be captured during step 168, associated during step 176, stored during step 182, and continuously updated during steps 183 through 185 by performing step 186 multiple times per second (e.g., 100 times per second) during any movement of imaging device 20 relative to body part 4, such as movement 15 of FIG. 1.

As shown in FIG. 13, storage process 180 also may comprise outputting positioning instructions to user 1 (“outputting step 188”). For example, step 188 may comprise outputting fifth positioning instructions for moving imaging device 20 toward a different pose segment of plurality of pose segments 11 by guiding fifth additional movements of imaging device 20 relative to body part 4. A similar step 188 may be performed after step 182 of FIG. 12. As shown in FIG. 1A, for example, a first portion of pose segments 11A-X may be occupied by pose segments 13, meaning that at least one image may be stored with reference thereto; and a second portion of pose segments 11A-X may be unoccupied segments 14, meaning that no images have been stored with reference thereto. Accordingly, the fifth positioning instructions may be output to guide movements of imaging device 20 from current pose segment 12 to either one of unoccupied segments 14 to store a new image or one of occupied segments 13 to replace a previously stored image with the new image.

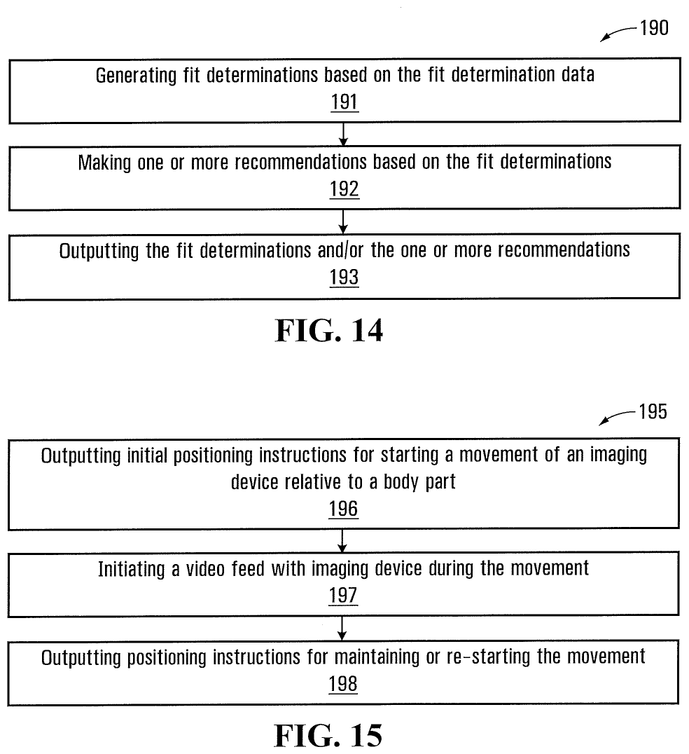

As shown in FIG. 14, method 100 may comprise a fit determination process 190 based on the fit determination data generated and/or improved during storage process 180. For example, fit determination process 190 of FIG. 14 may comprise: generating fit determinations based on the fit determination data (“generating step 191”); making one or more recommendations based on the fit determinations (“recommending step 192”); and outputting the fit determinations and/or the one or more recommendations (“outputting step 193”).

Generating step 191 and/or recommendation step 192 may comprise any mathematical means for generating the fit determinations and the one or more recommendations. Aspects of steps 191 and 192 may be performed with imaging device 20. For example, neural network 70 may be trained to perform generating step 191 and recommending step 192 according to additional machine learning processes. Aspects of steps 191 and 192 may alternatively be performed with image processor 90 of FIG. 2. For example, step 191 may comprise outputting the fit determination data to image processor 90, and step 192 may comprise inputting the one or more recommendations from image processor 90. Outputting step 193 may comprise communicating the fit determinations and/or the one or more recommendations to user 1 via any visual or non-visual means, including any combination of outputs from visual display portion 44, sound generator 24, and/or haptic communicator.

As described above, aspects of this disclosure may be utilized to generate highly accurate fit determinations by efficiently capturing high-quality images of body part 4, and generating highly accurate fit determinations for body part 4 based on the high-quality images. For feet 5 and 6 of FIG. 1, for example, the fit determinations may comprise a predicted length with an error rate of less than 1% so that the one or more recommendations from step 190 may comprise a selection of footwear that is highly likely to fit feet 5 and 6.

Additional aspects of method 100 are now described with reference to the various positioning instructions described above; such as the first positioning instructions of step 123, the second positioning instructions of step 144, the third positioning instructions of step 149, the fourth positioning instructions of step 153, and the fifth positioning instructions of step 188. As described above, each of these positioning instructions may be output to guide additional movements of imaging device 20 relative to body part 4.

As shown in FIG. 1, the additional movements may be responsive to movement 15. For example, viewpoint region 10 may comprise a circular area comprising positions where imaging device 20 may be at approximately the same elevation with respect to body part 4; movement 15 may comprise a circular path extending through these positions; and the additional movements may comprise rotations for orienting image device 20 relative to body part 4 at various points during movement 15. As shown in FIG. 1, the rotations may comprise a first rotation 16 about a first device axis x-x and/or a second rotation 17 about a second device axis y-y. Rotations 16 and/or 17 may be utilized to detect body part 4 in the frame, as with the first positioning instructions of step 123; and/or centre body part 4 in the frame, as with the third positioning instructions of step 149. Other additional movements are contemplated. For example, the third additional movements of step 149 may comprise translation movements for modifying the characteristic measured during step 148, such as a forward or backward movement of device 20 along the circular path; and the fourth and fifth positioning instructions of steps 153 and 188 may comprise rotations and/or translational movements for guiding device 20 between discrete positions on the circular path.

Because aspects of method 100 may be performed continuously during any movement of imaging device 20, such as first processing step 130, the positioning instructions also may be output continuously. Accordingly, method 100 also may comprise a guide process 195 for continuously outputting the positioning instructions during any movement of imaging device 20 relative to body part 4. As shown in FIG. 15, for example, guide process 195 may comprise: outputting initial positioning instructions for starting a movement of imaging device 20 relative to a body part (“first guiding step 196”); initiating the video feed of body part 4 with device 20 in response to the movement (“initiating step 197”); and outputting additional positioning instructions for maintaining or restarting the movement during the video feed (“second guiding step 198”).

As shown in FIGS. 1 and 1A, for example, first guiding step 196 may comprise guiding imaging device 20 to a start position for movement 15. The start position may be relative to any pose segment of plurality of pose segments 11, such as segment 11A (e.g., for a counter-clockwise movement 15) or segment 11M (e.g., for a clock wise movement 15). In some aspects, initiating step 197 may be performed in response to an input from user 1 (e.g., via touchscreen portion 42) and/or an output from measurement unit 54 (e.g., position data indicating that movement 15 has begun). Second guiding step 198 may comprise performing any combination of outputting steps 123, 144, 149, 153, and/or 188 to maintain or re-start the movement. For example, step 198 may comprise continuously performing one or both of steps 123 and 149 to maintain an alignment of imaging device 20 with body part 4 during movement 15 with the first or second positioning instructions; continuously performing step 149 to modify the motion characteristic during movement 15 with the third positioning instructions; and/or intermittently performing step 153 and/or 188 to continue movement 15 by replacing the initial positioning instructions with the fourth or fifth positioning instructions.

As noted above, any positioning instruction described herein may be visual and/or non-visual. For example, each first, second, third, fourth, and/or fifth positioning instructions may comprise any combination of a graphics output with visual display portion 44, sounds output with sound generator 24, and/or haptics output with haptic communicator 26; and each combination may guide any of the first, second, third, fourth, and/or fifth additional movements described herein and any movements related thereto.

As shown in FIG. 1, sight line L between visual display portion 44 and user 1 may be maintained during movement 15 so that, as shown in FIG. 1A, portion 44 may output the video feed and positioning instructions comprising: augmented reality element 45 and visual signal 46. As also shown in FIG. 1A, visual signals 46 may comprise: a dynamic display element 47 responsive to position data from measurement unit 54; and a fixed display element 48 operable with dynamic display element 47 to guide additional movements the imaging device 20. For example, dynamic display element 47 may comprise a marker and fixed display element 48 may comprise a target such that: moving device 20 relative to part 4 causes corresponding movements of the marker relative to the target; and moving the marker to the target guides the additional movements.

As also shown in FIG. 1A, the marker may comprise a graphical representation of a ball and the target may comprise a graphical representation of a hole for the ball and a track leading into the hole, such that the additional movements are guided by moving the ball along the track and into the hole. Other graphical representations may be used to guide the additional movements. For example, the marker may comprise a graphical representation of an arrow and the target may comprise a graphical representation of a compass, such that the additional movements are guided by moving the compass relative to the arrow.

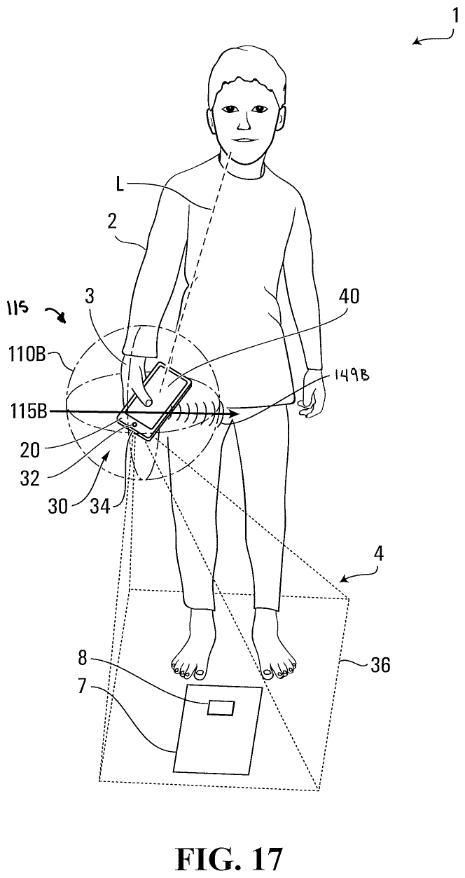

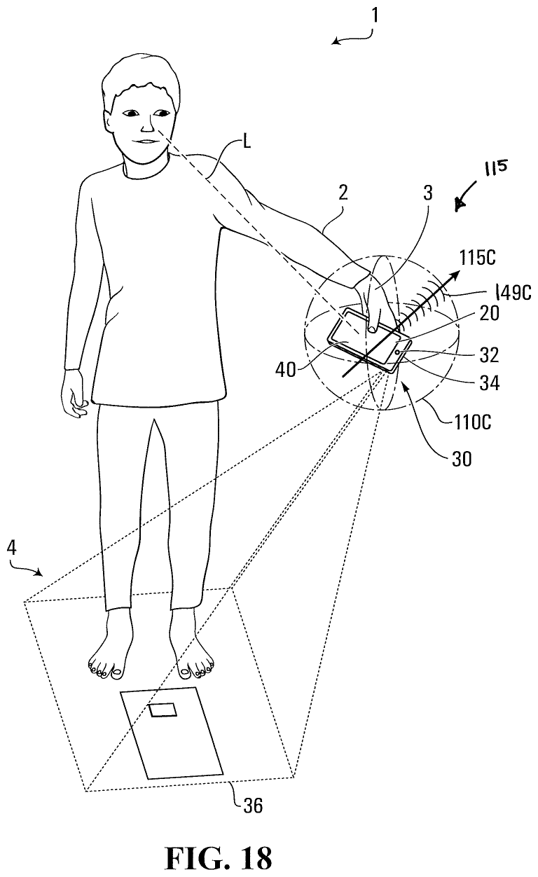

Guide process 195 of FIG. 15 may be similarly performed for segmented movement 115 of FIGS. 16-18. As shown in FIGS. 16-18, movement 115 may comprise three segment movements, such as a first segmented movement 115A of FIG. 16, a second segmented movement 115B of FIG. 17, and a third segmented movement 115C of FIG. 18. Each segmented movement 115A, 115B, and 115C may move imaging device 20 between a different viewpoint region, such as a first viewpoint region 110A of FIG. 16, a second viewpoint region 1108 of FIG. 17, and a third viewpoint region 1100 of FIG. 18. Each viewpoint region 110A, 110B, and 110C may comprise different groupings of positions (shown conceptually as spherical areas including the positions); and the groupings may be spaced apart around body part 4 so that azimuth angle 0 each region 110A, 110B, and 110C is different. For example, first locating step 173 also may comprise locating viewpoint regions 110A, 110B, and 110C relative to body part 4; first guiding step 196 may comprise guiding imaging device 20 between viewpoint regions 110A, 110B, and 14; initiating step 197 may comprise initiating the video feed when moving device 20 relative to each viewpoint region 110A, 110B, and 110C; and second guiding step 198 may comprise aligning imaging device 20 with body part 4 at each region 110A, 1108, and 110C.

As shown in FIGS. 16-18, a sight line L between visual display portion 44 and user 1 also may be maintained during movements 115A, 115B, and 115C so that positioning instructions output from visual display portion 44 may similarly guide aspects of movements 115A, 115B, and 115C. For example, as above, the interaction of dynamic display element 47 and fixed display element 48 may be used within each viewpoint region 110A, 110B, and 110C to guide additional movements of imaging device 20 for detecting and/or centring body part 4 in the frame.

FIGS. 16-18 optionally show non-visual signals 149A, 149B, and 149C as being output from imaging device 20 to guide aspects of respective segmented movements 115A, 115B, and 115C in combination with the positioning instructions output with visual display portion 44. As shown, non-visual signals 149A, 149B, and 149C may comprise sounds output with sound generator 24 and/or haptics output with haptic communicator 26 to reinforce visual signal 46 during each segmented movement 115A, 115B, and 115C. For example, each non-visual signal 149A, 149B, and 149C may indicate whether imaging device 20 is being moved correctly toward and/or between any of regions 110A, 110B, and/or 110C. Non-visual signals 149A, 149B, and 149C may be output in a hot and cold manner. For example, each signal 149A, 149B, and 149C may comprise a first or hot signal output (e.g., a first sound and/or vibration) when the device 20 is being moved correctly and a second or cold signal (e.g., a second sound and/or vibration) when device 20 is being moved incorrectly.

Guide process 195 of FIG. 15 also may be similarly performed for movement 215 of FIG. 19, which may comprise any movement path 210 relative to body part 4. In this example, user 1 may arbitrarily select any start point for movement path 210, and then move device 20 along path 210 based on positioning instructions without reference to a pre-defined viewpoint region such as region 10 of FIG. 1. Accordingly, outputting step 196 may comprise guiding imaging device 20 along movement path 210; initiating step 197 may comprise initiating the video feed at points along path 210; and outputting step 198 may comprise aligning imaging device 20 with body part 4 at one or more of the points.

As shown in FIG. 19, a sight line L between visual display portion 44 and user 1 may or may not be maintained during movement 215. If sight line L is maintained, then visual signals 46 may be used to guide movement 215 as before. If the sight line is not maintained, as shown in FIG. 19, then movement 215 may be guided entirely by non-visual signals 249. For example, first guiding step 196 may comprise outputting first non-visual signals 249 (e.g., first sounds and/or vibrations) to identify a first stop position along path 210 where body part 4 is detected in the frame during step 120; second guiding step 198 may comprise outputting second non-visual signals 249 (e.g., second sounds and/or vibrations) to align imaging device 20 with body part 4 at the first stop position; and step 198 may comprise outputting third non-visual signals 249 (e.g., third sounds and/or vibrations) to identify a second stop position along path 210.

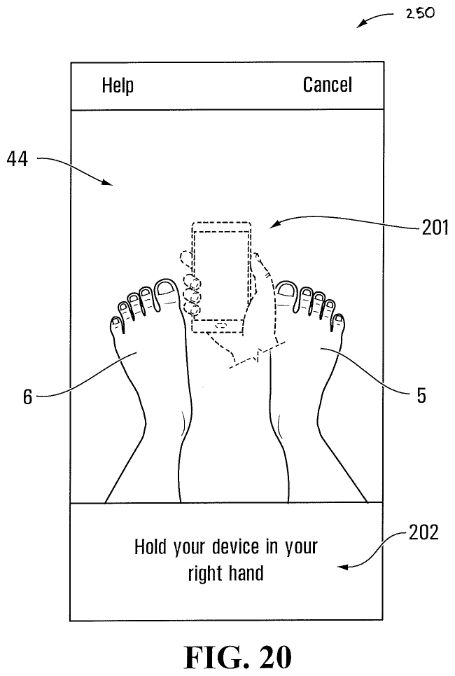

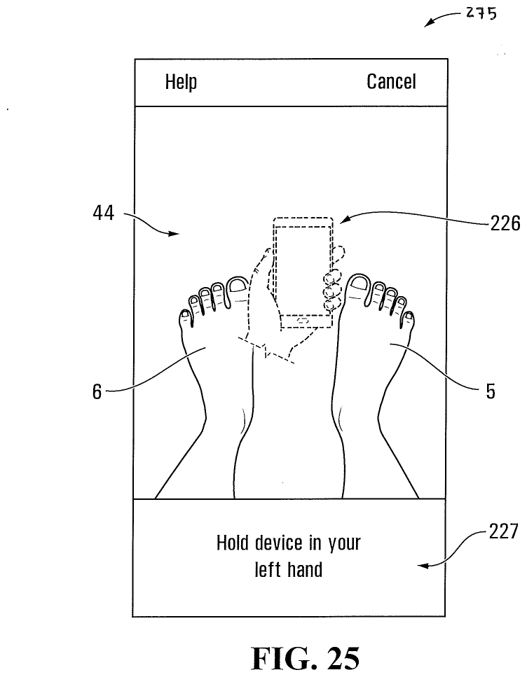

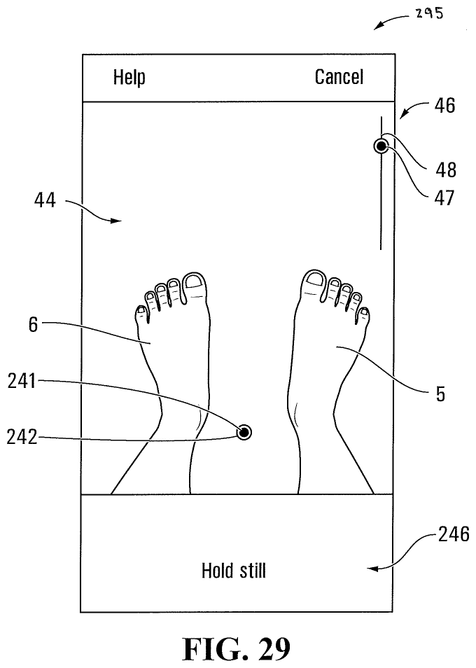

Additional aspects of method 100 are now described with reference to FIGS. 20-29, which show exemplary screenshots 250 through 295 of visual display portion 44 during method 100. As shown, the video feed may be displayed with visual display portion 44 during each screenshot 250-295; body part 4 may comprise right foot 5 and left foot 6 of FIG. 1; and FIGS. 20-29 may correspond to any movement of imaging device 20 relative to feet 5 and 6, such as movement 15 of FIG. 1, movement 115 of FIGS. 16-18, and movement 215 of FIG. 19. In these examples, screenshot 270 of FIG. 25 may correspond with a first start position of the movement; and screenshot 295 of FIG. 29 may correspond with a second start position of the movement.

As shown in screenshot 250 of FIG. 20, method 100 may comprise outputting positioning instructions comprising a first starting element 201 and an instruction 202. For example, starting element 201 may comprise a graphical display element showing user 1 how to grip imaging device 20 and instruction 202 may provide corresponding written instructions. Accordingly, user 1 may be guided by screenshot 250 to grip imaging device 20 in a particular way in a first hand of user 1.

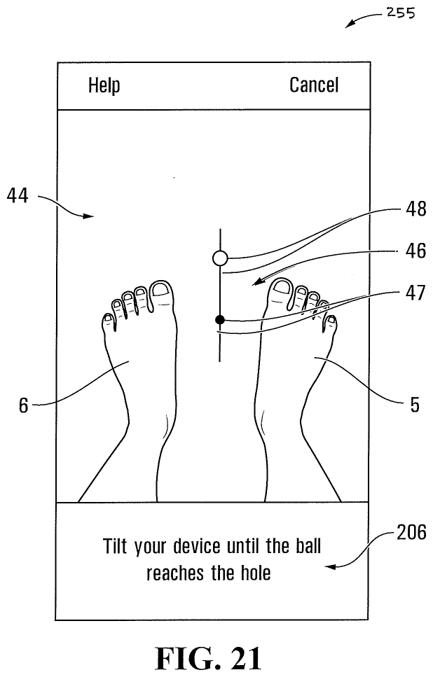

Additional movements of imaging device 20 may be required to orient camera 20 relative to body part 4. For example, as shown in screenshot 255 of FIG. 21, starting element 201 may be replaced with visual signals 46 of FIG. 1A. As shown, dynamic element 47 may be spaced apart from fixed element 48 to guide user 1 to perform first rotation 16 about first device axis x-x and/or second rotation 17 about second device axis y-y (e.g., FIG. 1). An instruction 206 may provide corresponding written instructions. As before, dynamic element 47 of FIG. 21 may represent a ball and fixed element 48 may represent a hole for the ball and a track leading into the hole so that the additional movements may be guided by moving the ball along the track and into the hole.

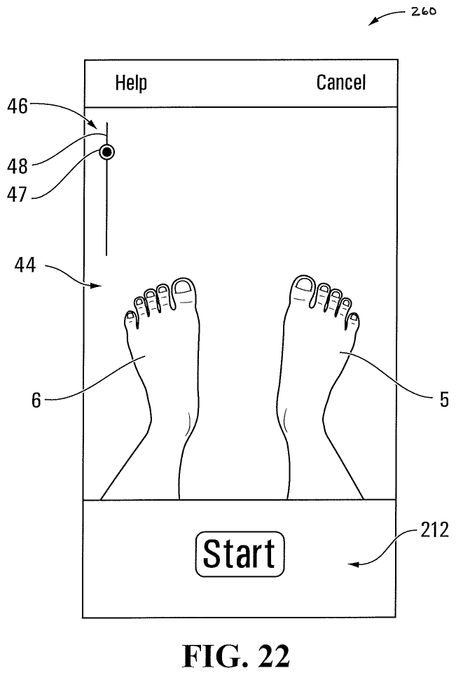

As shown in screenshot 260 of FIG. 22, visual signals 46 may be moved to an upper-left portion of visual display portion 44 once imaging device 10 has been rotated to locate element 47 within element 48. User 1 may be required to maintain the rotation. Therefore, dynamic element 47 may remain active so that elements 47 and 48 may continue to guide user 1 to maintain the rotated position. An instruction 212 may be provided.

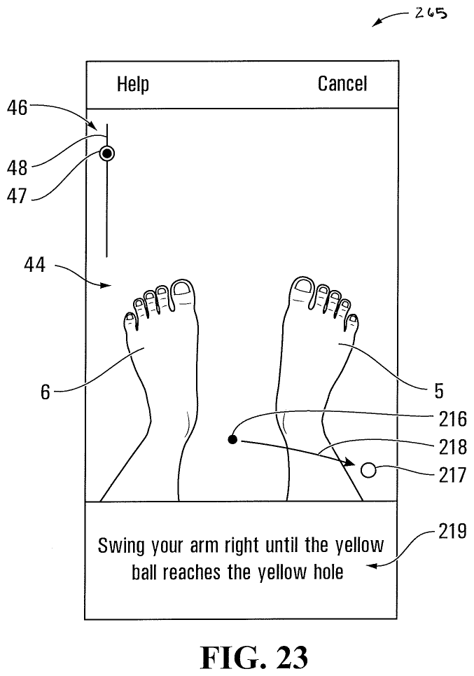

More additional movements may be required to locate imaging device 20 at the first position while maintaining the rotation of imaging device 20. As shown in screenshot 265 of FIG. 23, for example, method 100 may comprise outputting additional positioning instructions comprising a dynamic visual element 216, a fixed visual element 217, and a directional arrow 218. Dynamic element 216 may be spaced apart from fixed element 217 to communicate that imaging device 20 must be moved relative to body part 4 in a direction consistent with arrow 218. An instruction 219 may provide corresponding written instructions. For example, element 216 may again represent a ball, arrow 218 may again represent a track for the ball, and element 217 may again represent a hole so that the additional movements may be further guided by moving the ball along the track and into the hole.

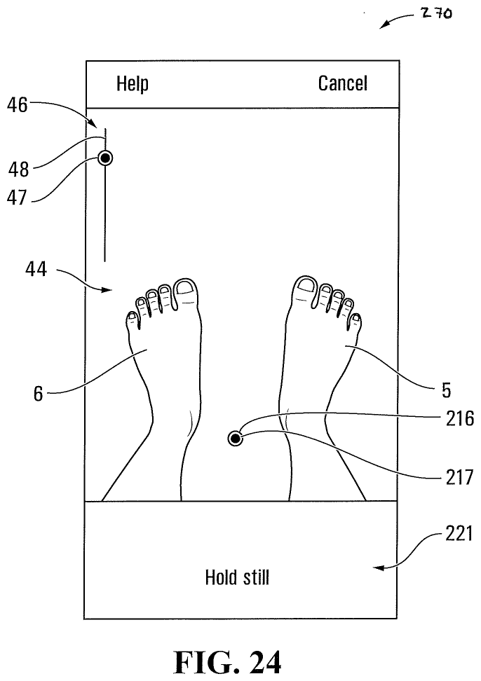

As shown in screenshot 270 of FIG. 24, the first start position may correspond with any position where dynamic element 47 is located within fixed element 48 and dynamic element 216 is located within fixed element 217. Method 100 may comprise outputting an instruction 221 guiding user 1 to maintain the first start position. In some aspects, instruction 221 may guide user 1 to maintain the first position for a fixed period of time (e.g., 3 seconds) so that steps 110, 120, 130, 150, and 160 may be performed for first foot 5 during a relatively still portion of the movement. For example, associating step 172 and storage process 180 may be performed at the first position, resulting in fit determination data for foot 5.

As shown in screenshot 275 of FIG. 25, method 100 also may comprise outputting positioning instructions comprising a second starting element 226 and an instruction 227. For example, second starting element 226 (like first starting element 201) may comprise a graphical display element showing user 1 how to grip imaging device 20 and instructions 227 may provide corresponding written instructions. Accordingly, user 1 may be guided by screenshot 250 to grip imaging device 20 in a particular way in a second hand of user 1.

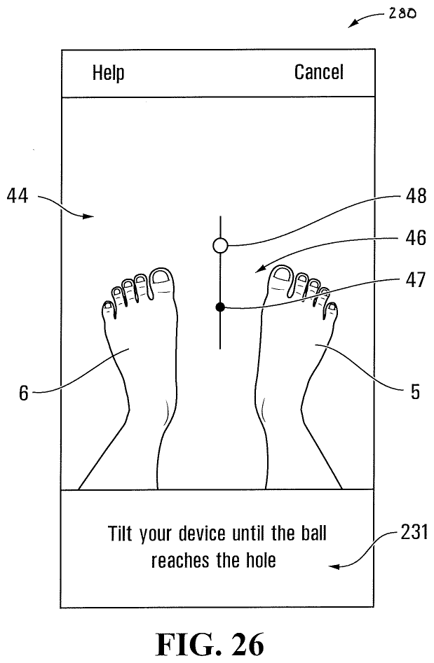

Additional movements of imaging device 20 may again be required to orient camera 20 relative to body part 4. For example, as shown in screenshot 280 of FIG. 26, starting element 226 may again be replaced with visual signals 46 of FIG. 1A; and dynamic visual element 47 may again be spaced apart from fixed visual element 48 to guide user 1 to perform first rotation 16 about first device axis x-x and/or second rotation 17 about second device axis y-y (e.g., FIG. 1). An instruction 231 may provide corresponding written instructions. For example, as before, dynamic element 47 may again represent a ball and fixed element 48 may again represent a hole for the ball and a track leading into the hole so that the additional movements may again be guided by moving the ball along the track.

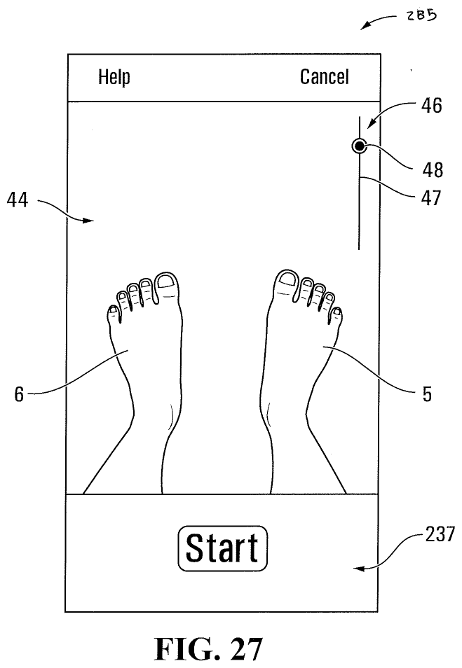

As shown in screenshot 285 of FIG. 27, visual signals 46 may be moved to an upper-right portion of visual display portion 44 once imaging device 10 has been rotated to locate element 47 within element 48. User 1 may again be required to maintain the rotation. Therefore, dynamic element 47 may again remain active so that elements 47 and 48 may continue to guide user 1 to maintain the rotated position.

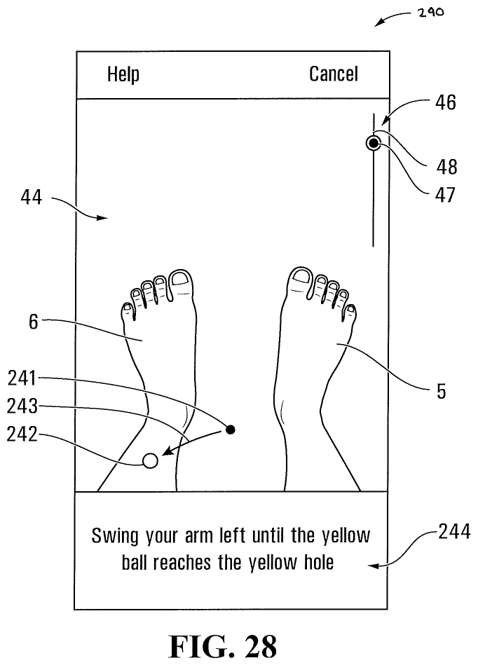

More additional movements may again be required at the second position while maintaining the rotation of imaging device 20. As shown in screenshot 290 of FIG. 28, for example, method 100 may comprise outputting additional positioning instructions comprising a dynamic visual element 241, a fixed visual element 242, and a directional arrow 243 extending therebetween. As before, dynamic element 241 may be spaced apart from fixed element 242 to communicate that imaging device 20 must be moved in a direction consistent with arrow 243. An instruction 244 may provide corresponding written instructions. For example, element 241 may again represent a ball, arrow 243 may again represent a track for the ball, and element 242 may again represent a hole so that the additional movements may be guided therewith.

As shown in screenshot 295 of FIG. 29, the second start position may correspond with any position where dynamic element 47 is again located within fixed element 48 and dynamic element 241 is located within fixed element 242. Method 100 may comprise outputting an instruction 246 instructing user 1 to maintain the second start position. In some aspects, instruction 246 may again guide user 1 to maintain the second position for a fixed period of time (e.g., 3 seconds) so that steps 110, 120, 130, 150, and 160 may be performed for second foot 6 during another relatively still portion of the movement. For example, associating step 172 and storage process 180 may again be performed at the second position, resulting in fit determination data for foot 6.

Although not shown in FIGS. 20-29, it is contemplated that any positioning instructions described in relation thereto may comprise any combination of visual and/or non-visual signals. For example, any movements guided visually by the interaction of dynamic element 47 with fixed element 48 (FIGS. 21 and 26), dynamic element 216 with fixed element 217 (FIG. 23), and/or dynamic element 241 with fixed element 242 (FIG. 28) may likewise be guided non-visually with additional or alternative positioning instructions output with sound generator 24 and/or haptic communicator 26. For example, a first audio and/or haptic signal may be output responsive to dynamic element 47 and a second audio and/or haptic signal may be output responsive to dynamic elements 216 and 241 so that user 1 may be continuously guided non-visually during any movement of device 20.

It is further contemplated that movements of imaging device 20 may likewise be guided entirely with non-visual signals. For example, the function of visual signals 46 may likewise be performed by any non-visual signal comprising any combination of audio and/or haptic signals configured to guide movements of imaging device 20. As shown in FIG. 16-18, for example, the non-visual signals may be output to in various patterns and/or combinations to guide each segmented movement 115A, 115B, and 115C of movement 115. And as shown in FIG. 19, the non-visual signals may likewise comprise any pattern of hot and cold signals output to guide movements along path 215.

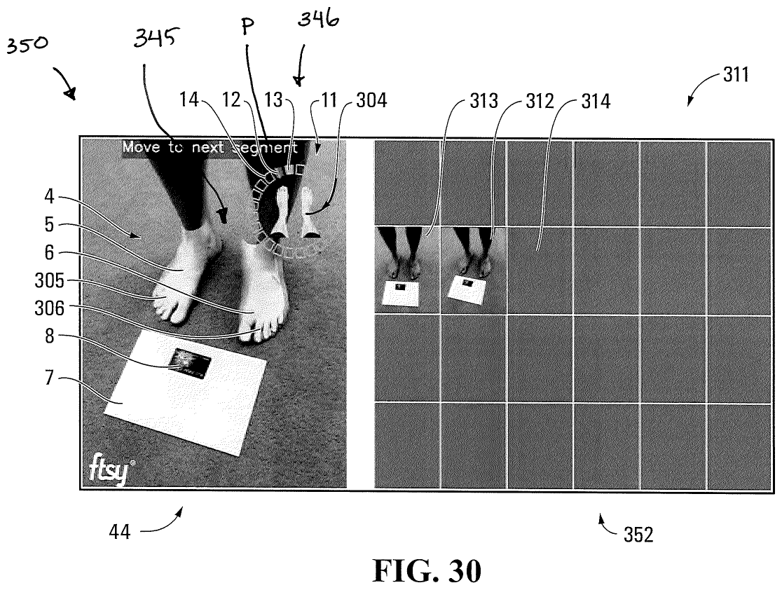

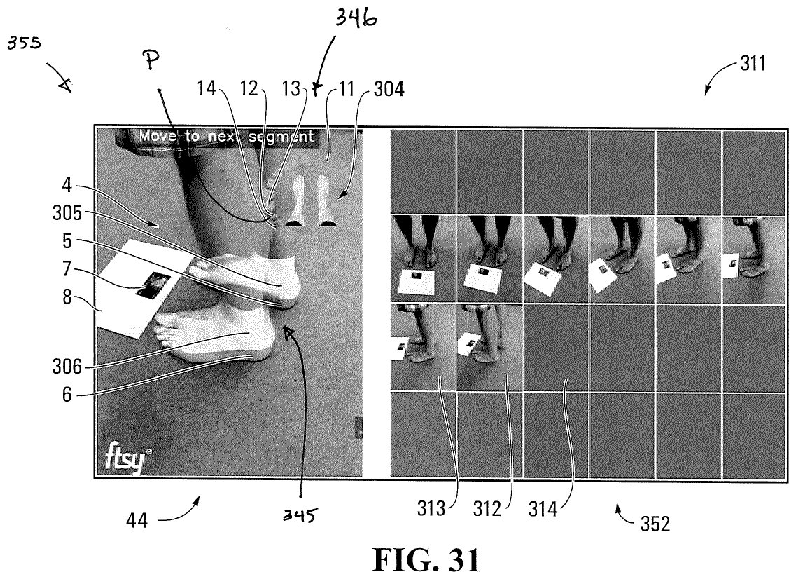

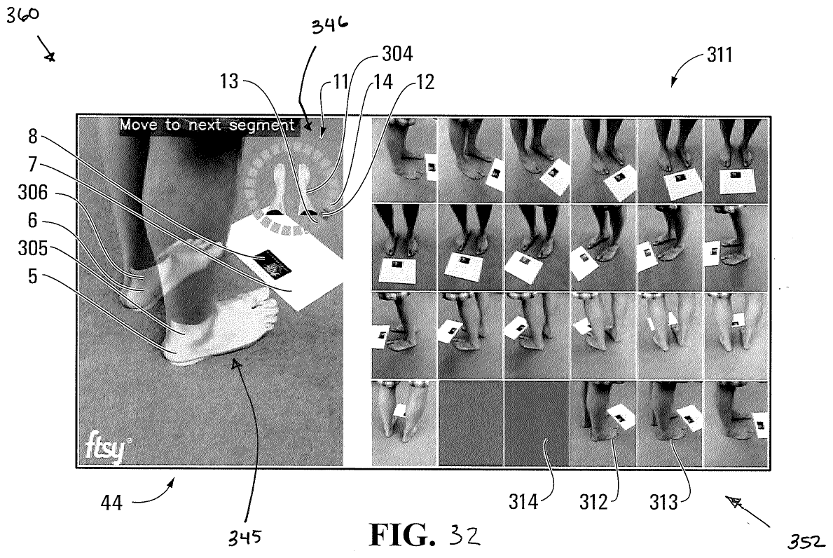

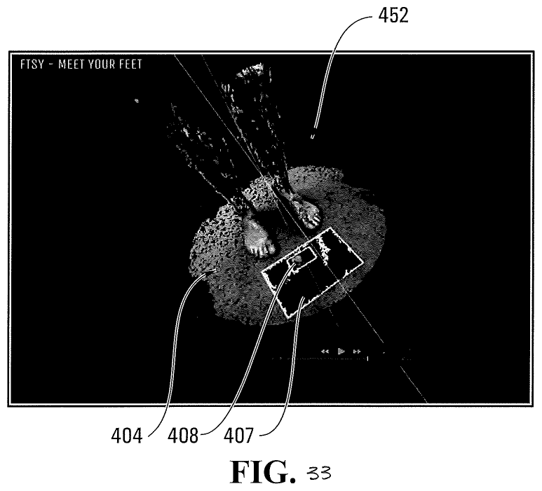

Additional aspects of method 100 are now described with reference to FIGS. 30-32, which show exemplary screenshots 350 through 360 of visual display portion 44 during method 100 at left and corresponding depictions of exemplary fit determination data 352 at right. As shown, the video feed may be displayed with visual display portion 44 during each screenshot 350-360; body part 4 may comprise right foot 5 and left foot 6 of FIG. 1; and FIGS. 30-32 may correspond to any movement of imaging device 20 relative to feet 5 and 6, such as movement 15 of FIG. 1, movement 115 of FIGS. 16-18, and movement 215 of FIG. 19. In these examples, screenshot 350 FIG. 30 may correspond with a near-start position of the movement; screenshots 355 of FIG. 31 may correspond with an intermediate position of the movement; and screenshot 360 of FIG. 32 may correspond with a near-final position of the movement.

In keeping with above, method 100 may comprise outputting visual and/or non-visual positioning instructions to guide the movement. In contrast to FIG. 1A, for example, each visual display portion 44 shown in FIGS. 30-32 may comprise: the video feed; an augmented reality element 345; and a visual signal 346. The video feed may comprise a depiction of body part 4 (shown as feet 5 and 6 in this example), brightness reference area 7, and scaling object 8. Augmented reality element 345 may comprise a first foot element 305 overlaid onto first foot 5 and a second foot element 306 overlaid onto second foot 6. And visual signal 346 may comprise: a depiction 304 of body part 4 (e.g., feet 5 and 6) surrounded by plurality of pose segments 11.

As shown in screenshots 350-360 of FIGS. 30-32, visual signal 346 may comprise a position line P (e.g., similar to FIG. 1A) that moves between plurality of pose segments 11 to define a current segment 12 of plurality of pose segments 11 responsive to the movement of device 20. Aspects of visual signal 346 may indicate whether each pose segment 11 is an occupied segment 13 or an unoccupied segment 14 (e.g., as defined above). As shown in FIGS. 30-32, for example, each current segment 12 may comprise a first type of shading (e.g., a first colour); each occupied segment 13 may comprise a second type of shading (e.g., a second colour); and each unoccupied segment 14 may comprises a third type of shading (e.g., no colour). As also shown in FIGS. 30-32, the movement may cause the images to be captured during step 168 in a sequence so that each segment 12 is located between one of segments 13 and 14.

As shown at right in FIGS. 30-32, fit determination data 352 may be structured according to plurality of pose segments 11. For example, plurality of pose segments 11 may comprise twenty-four (24) different segments; fit determination data 350 may comprise twenty-four (24) different bins 311; and a location of each bin 311 may correspond with a location of each pose segment 11. In this example, current segment 12 may correspond with a current bin 312; each occupied segment 13 may correspond with a different occupied bin 313; and each unoccupied segment 14 may correspond with a different unoccupied segment 314. As shown conceptually in FIGS. 30-32, the respective segment markings 12, 13, and 14 may be movable with their corresponding bin markings 312, 313, 314 responsive to the movement of imaging device 20 relative to body part 4.

FIG. 31 shows aspects of how fit determination data 352 may be continuously generated during the movement of device 20. For example, FIG. 31 at left shows the intermediate position, in which: imaging device 20 has been moved further around body part 4, current segment 12 has moved six additional segments responsive to the movement of device 20, eight of the twenty-four segments 11 are now occupied segments 13 (including now current segment 12), and the remaining sixteen segments 11 are now unoccupied segments 14. And FIG. 31 at right correspondingly shows that current bin 312 has moved six additional segments responsive to the movement of device 20, eight of the twenty-four bins 311 are now occupied bins 313 (including now current bin 312), and the remaining sixteen bins 311 are now unoccupied bins 314.

FIG. 32 shows similar aspects. For example, FIG. 32 at left shows the near-final position, in which: imaging device 20 has been moved nearly all the way around body part 4, current segment 12 has moved ten additional segments responsive to the movement of device 20, twenty-two of the twenty-four segments 11 are now occupied segments 13 (including now current segment 12), and the remaining two segments 11 are now unoccupied segments 14; and FIG. 32 at right likewise shows that current bin 312 has moved ten additional segments responsive to the movement of device 20, twenty-two of the twenty-four bins 311 are now occupied bins 313 (including now current bin 312), and the remaining two bins 311 are now unoccupied bins 314.

Together, FIGS. 30-32 show how fit determination data 350 may be generated during method 100. In particular, these FIGS. 30-32 show that each pose segment 11 may correspond with a different viewpoint of body part 4, and that fit determination data 352 may be continuously populated by moving imaging device 20 between these viewpoints. In complement, FIGS. 30-32 also how each pose segment 11 may correspond in a different bin 311 so that the location of each bin 311 may serve as the reference for each image stored in data 352.

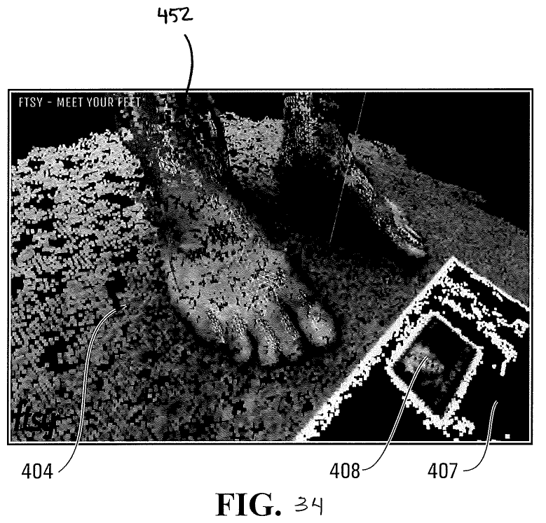

Additional aspects of method 100 are now described with reference to FIGS. 33 and 34, which show an exemplary 3D reconstruction 452 generated based on fit determination data 352. As shown in FIGS. 33 and 34, 3D reconstruction 452 may comprise a plurality of points located in a 3D model space based on fit determination data 352 to depict at least a representation 404 of body part 4 and a 408 representation of scaling object 8. For example, 3D reconstruction 452 of FIGS. 33 and 34 also may comprise a representation 407 of brightness reference area 7, if needed accommodate floor patterns when body part 4 comprises feet 5 and 6. The plurality of points may be located in the 3D model space by imaging device 20 and/or image processor 90 during fit determination process 190 and utilized to make the one or more recommendations during step 193. As further shown in FIG. 34, 3D reconstruction 452 may be accurately scaled to match body part 4 and thus reliably useable by one or both of imaging device 20 and/or image processor 90 during determination process 190.

As described above, aspects of this disclosure may be utilized to generate highly accurate fit determinations for any body part 4 by efficiently capturing high-quality images of body part 4, and generating highly accurate fit determinations for body part 4 based on the high-quality images. In some aspects, because of the program structures described herein, imaging device 20 may be configured to perform the method 100 without the aid of any specialized body scanning hardware. For feet 5 and 6 of FIG. 1, for example, the fit determinations may comprise a predicted length with an error rate of less than 1% so that recommendations from step 190 may be confidently relied upon. Similar recommendations may be made for any body part 4.

While principles of the present disclosure are disclosed herein with reference to illustrative aspects of particular applications, the disclosure is not limited thereto. Those having ordinary skill in the art and access to the teachings provided herein will recognize the additional modifications, applications, aspects, and substitution of equivalents may all fall in the scope of the aspects described herein. Accordingly, the present disclosure is not to be considered as limited by the foregoing descriptions.

1. A computer-implemented method performable with an imaging device, the method comprising:
selecting a frame from a video feed output with the imaging device during a movement of the imaging device relative to a body part;
detecting the body part in the frame;
performing, if the body part is detected, a first process comprising:
calculating an azimuth angle of the imaging device relative to the body part;
calculating a metering region for the body part; and
measuring a motion characteristic of the movement;
qualifying the frame based on at least one of the azimuth angle and the motion characteristic; and
performing, if the frame is qualified, a second process comprising:
adjusting a setting of the imaging device based on the metering region;
capturing an image of the body part with the imaging device based on the setting;
identifying a location of the image relative to the body part based on the azimuth angle; and
associating the image with a reference to the location.

2. The method of claim 1, wherein the body part pixels are identified with a machine learning process.

3. The method of claim 2, wherein the machine learning process comprises:
inputting each frame to a deep convolutional neural network;
applying, with the deep convolutional neural network, transforming feature layers to each image; and
outputting, with the deep convolutional neural network, predictions for the body part in each image.

4. The method of claim 3, comprising outputting, with deep convolutional neural network, a confidence score for each image.

5. The method of claim 1, wherein detecting the body part in the frame comprises:
identifying body part pixels in the frame by:
calculating a body part probability for each pixel of the frame by applying a hierarchy of known body part pixel characteristics to each pixel; and
thresholding the calculated body part probabilities based on a predetermined value to generate a binary image comprising clusters of the body part pixels; and
identifying body part features based on the body part pixels by:
calculating a body part probability for each cluster of the body part pixels by applying a hierarchy of known body part features to each cluster; and
detecting of the body part based on the body part probabilities

6. The method of any one of claims 2 to 5, comprising outputting first positioning instructions for locating the body part in the frame by guiding first additional movements of imaging device during the movement.

7. The method of claim 1, wherein the first process is performed continuously when the video feed is being output with the imaging device.

8. The method of claim 1, wherein calculating the azimuth angle comprises mapping the azimuth angle on the frame.

9. The method of claim 8, wherein calculating the azimuth angle comprises predicting the azimuth angle with a machine learning process.

10. The method of claim 1, wherein calculating the azimuth angle comprises:
calculating first predictions of the azimuth angle with a first prediction process;
calculating second predictions of the camera azimuth angle with a second prediction process; and
calculating the azimuth angle based on the first predictions and

11. The method of claims 10, wherein at least the first prediction process is based on a machine learning process.

12. The method of claim 11, wherein the second prediction process is based on at least one of:
an output from a measurement unit of the imaging device; and
a simultaneous localization and mapping algorithm.

13. The method of any one of claims 10 to 12, wherein:
the first predictions are generated at a first rate;
the second predictions are generated at a second rate; and
the first rate is different from the second rate.

14. The method of claim 13, comprising determining a confidence level of the azimuth angle based on one or more of the first estimates, the second estimates, and the combination thereof.

15. The method of claim 14, wherein the determining the confidence level comprises continuously analyzing the first estimates, the second estimates, or the combination thereof during the movement.

16. The method of claim 1, wherein the metering region is calculated based on a machine learning process.

17. The method of claim 1, wherein calculating the metering region comprises:
generating a per-pixel body part probability for each pixel of the frame;
thresholding the per-pixel body part probabilities to define a segmentation mask; and
calculating the metering region based on the segmentation mask.

18. The method of claim 17, comprising:
determining if the body part is centered in the frame; and
outputting second positioning instructions for centering the body part in the frame by guiding second additional movements of the imaging device.

19. The method of claim 1, wherein the motion characteristic comprises a movement speed of the imaging device relative to the body part.

20. The method of claim 19, wherein the movement speed is determined based on an output from a measurement unit of the imaging device.

21. The method of claim 20, comprising outputting third positioning instructions for modifying the movement speed by guiding third additional movements of the imaging device.

22. The method of claim 1, wherein qualifying the frame comprises:
determining if the azimuth angle is reliable based on a range of reliable azimuth angles; and
determining if the motion characteristic is acceptable based on a range of acceptable motion characteristics.

23. The method of claim 22, further comprising outputting fourth position instructions restarting the movement by guiding fourth additional movements of the imaging device

24. The method of claim 1, wherein imaging device comprises an optical camera, and adjusting the at least one setting of the imaging device comprises iteratively adjusting one of a focus, an exposure, and a gain of the optical camera.

25. The method of claim 1, wherein identifying the location of the image relative to the body part comprises:
locating a plurality of pose segments relative to the body part; and
locating the image relative to one pose segment of the plurality of pose segments.

26. The method of claim 25, wherein associating the image with the reference to the location comprises associating the image with the one pose segment of the plurality of pose segments.

27. The method of claim 26, comprising:
storing the image and the reference to the one pose segment as fit determination data; and
returning to the selecting step until the fit determination data comprises at least one image stored with reference to each pose segment of the plurality of pose segments

28. The method of claim 26, comprising calculating a quality metric of the image.

29. The method of claim 28, comprising:
storing the image, the reference to the one pose segment, and the quality metric as fit determination data;
determining whether a previous image has been stored with reference to the one of the plurality of pose segments;
comparing the quality metric of the image with a quality metric of the previous image;
updating the fit determination data at the reference to comprise one of the image and its quality metric or the previous image and its quality metric; and
returning to the selecting step until the fit determination data comprises at least one image stored with reference to each pose segment of the plurality of pose segments.

30. The method of claim 27 or 29, comprising outputting fifth positioning instructions for moving the imaging device toward a different pose segment of the plurality of pose segments by guiding fifth additional movements of the imaging device.

31. The method of claim 27 or 29, comprising:
generating fit determinations based on the fit determination data;
making one or more recommendations based on the fit determinations; and
communicating the fit determinations and the one or more recommendations to a user.

32. The method of claim 31, wherein generating the fit determinations comprises outputting the fit determination data to a remote image processor with fit determination instructions.

33. The method of any preceding claim, wherein the first, second, third, fourth, and fifth positioning instructions comprise one or more of a visual signal, an audible signal, and a haptic signal output to guide the respective first, second, third, fourth, or fifth additional movements.

34. The method of claim 33, wherein the visual signal comprises:
a dynamic display element responsive to the first, second, third, fourth, or fifth additional movements of the imaging device relative to the body part; and
a fixed display element operable with the dynamic display element to guide the respective first, second, third, fourth, or fifth additional movements.

35. The method of claim 34, wherein the dynamic display element comprises a marker and the fixed display element comprises a target such that:
moving the imaging device causes a corresponding movement of the marker relative to the target; and
moving the marker to the target guides the respective first, second, third, fourth, or fifth additional movements.

36. The method of claim 35, wherein the marker comprises a representation of a ball and the target comprises a representation of a hole or track for the ball.

37. The method of claim 36, wherein the marker comprises a compass.

38. The method of claim 1, comprising:
outputting initial positioning instructions for starting the
outputting subsequent positioning instructions for maintaining or restarting movement.

39. The method of claim 38, wherein the movement comprises a motion path extending at least partially around the body part.

40. The method of claim 39, wherein the motion path is segmented.

41. A computer-implemented method performable with an imaging device, the method comprising:
selecting a frame from a video feed output with the imaging device during a movement of the imaging device relative to a body part;
detecting, with a neural network, the body part in the frame;
performing, if the body part is detected, a first process comprising:
calculating, with the neural network, an azimuth angle of the imaging device relative to the body part;
calculating, with the neural network, a metering region for the body part; and
measuring a motion characteristic of the movement;
qualifying the frame based on at least one of the azimuth angle and the motion characteristic; and
performing, if the frame is qualified, a second process comprising:
adjusting a setting of the imaging device based on the metering region;
capturing an image of the body part with the imaging device based on the setting;
identifying a location of the image relative to the body part based on the azimuth angle; and
associating the image with a reference to the location.

42. A computer-implemented method performable with an imaging device, the method comprising:
outputting positioning instructions for guiding a movement of an imaging device relative to a body part;
initiating a video feed with the imaging device during the movement;
selecting a frame from the video feed during the movement;
detecting the body part in the frame;
performing, if the body part is detected, a first process comprising:
calculating an azimuth angle of the imaging device relative to the body part;
calculating a metering region for the body part; and
measuring a motion characteristic of the movement;
qualifying the frame based on at least one of the azimuth angle and the motion characteristic; and
performing, if the frame is qualified, a second process comprising:
adjusting a setting of the imaging device based on the metering region;
capturing an image of the body part with the imaging device based on the setting;
identifying a location of the image relative to the body part based on the azimuth angle; and
associating the image with a reference to the location.

43. The method of claim 42, wherein the positioning instructions guide the movement between different viewpoints of the body part, each different viewpoint having a different azimuth angle.

44. The method of claim 42, wherein the movement comprises a continuous motion extending in a random path about the body part.

45. The method of claim 42, wherein the movement comprises a continuous sweeping motion extending in a circular path around the body part.

46. The method of claim 42, wherein the movement comprises discrete motions extending between each viewpoint.

47. The method of claim 42, wherein the positioning instructions are output continuously during the movement.

48. The method of claim 42, wherein the positioning instructions comprises at least one of:
visual signals output with a display source of the imaging device;
audio signals output with a sound generator of the imaging device; and
haptic signals output with a haptic communicator of the image device.

49. The method of claim 42, wherein the positioning instructions comprise:
a dynamic display element output with the display source responsive to the inertial measurement unit; and
a fixed display element output with the display source and operable with the dynamic display element to guide compensatory movements of the imaging device relative to the body part.

50. The method of claim 49, wherein the dynamic display element comprises a marker and the fixed display element comprises a target such that:
moving the imaging device relative to the body part causes corresponding movements of the marker relative to the target; and
moving the marker to the target guides additional movements of the imaging device toward positions relative to the body part.

51. The method of claim 50, wherein the marker comprises a representation of a ball and the target comprises a representation of a hole or track for the ball.

52. The method of claim 50, wherein the marker comprises a rotating compass.

53. The method of claim 42, wherein the positioning instructions are responsive to the movement.

54. The method of claim 42, wherein identifying the location of the image relative to the body part comprises:
locating a plurality of pose segments relative to the body part, the plurality of pose segments comprising occupied segments and unoccupied segments;
locating the image at one of the unoccupied segments; and
storing the image in the memory with a reference to the one of unoccupied segments.

55. The method of claim 54, wherein the positioning instructions comprise an augmented reality element overlaid onto the video feed to provide a graphical representation of the plurality of pose segments.

56. The method of claim 55, wherein the positioning instructions guide movements relative to occupied and unoccupied segments of the plurality of pose segments.

57. The method of claim 56, comprising repeating the method until at least one image has been stored in the memory with reference to each of the unoccupied segments.

58. The method of claim 42, wherein measuring the motion characteristic comprises measuring a movement speed of the imaging device and the positioning instructions guide additional movements for modifying the movement speed of the imaging device.

59. The method of claim 58, wherein the positioning instructions are responsive to the additional movements.

60. The method of any one of claims 42 to 60, wherein the positioning instructions consist of non-visual signals.
